(19) United States
(12) Patent Application Publication
(10) Pub. No.: US 2011/0274987 A1
(43) Pub. Date: Nov. 10, 2011

(54) SECONDARY BATTERY, ELECTROLYTIC SOLUTION FOR SECONDARY BATTERY, CYCLIC POLYESTER, ELECTRIC POWER TOOL, ELECTRICAL VEHICLE, AND ELECTRIC POWER STORAGE SYSTEM

(75) Inventors: Masayuki Ihara, Fukushima (JP); Yuko Hayakawa, Fukushima (JP); Tadahiko Kubota, Kanagawa (JP)

(73) Assignee: SONY CORPORATION, Tokyo (JP)

(21) Appl. No.: 13/072,145

(22) Filed: Mar. 25, 2011

(30) Foreign Application Priority Data
Apr. 1, 2010 (JP) P2010-085216

(51) Int. Cl. H01M 10/0565; H01M 10/052

(52) U.S. Cl. 429/337

(57) ABSTRACT

A secondary battery capable of improving the cycle characteristics and the storage characteristics is provided. The secondary battery includes a cathode, an anode, and an electrolytic solution containing a nonaqueous solvent and an electrolyte salt. The nonaqueous solvent contains cyclic polyester obtained by dehydrating and condensing two or more divalent carboxylic acid and one or more divalent alcohol.

### CROSS REFERENCES TO RELATED APPLICATIONS

The present application claims priority to Japanese Priority Patent Application JP 2010-085216 filed in the Japanese Patent Office on Apr. 1, 2010, the entire contents of which is hereby incorporated by reference.

### BACKGROUND

The present application relates to a cyclic polyester; an electrolytic solution for a secondary battery containing a nonaqueous solvent and an electrolyte salt together with the cyclic polyester; a secondary battery using the cyclic polyester and the electrolytic solution for a secondary battery; an electric power tool, an electrical vehicle, and an electric power storage system using the secondary battery as an electric power source or an electric power storage source.

In recent years, small electronic devices represented by a portable terminal or the like have been widely used, and it is strongly demanded to further reduce their size and weight and to achieve their long life. Accordingly, as an electric power source for the small electronic devices, a battery, in particular, a small and light-weight secondary battery capable of providing a high energy density has been developed. In recent years, it has been considered to apply such a secondary battery not only to the foregoing small electronic devices but also to a large electronic devices represented by a motor vehicle or the like.

Specially, a lithium secondary battery using lithium reaction as charge and discharge reaction is largely prospective, since such a lithium secondary battery is able to provide a higher energy density than a lead battery and a nickel cadmium battery. The lithium secondary battery includes a lithium ion secondary battery using insertion and extraction of lithium ions and a lithium metal secondary battery using precipitation and dissolution of lithium metal.

The secondary battery includes an electrolytic solution together with a cathode and an anode. The cathode has a cathode active material layer on a cathode current collector. The anode has an anode active material layer on an anode current collector. In the electrolytic solution, an electrolyte salt and the like are dissolved in a nonaqueous solvent such as an organic solvent.

The composition of the electrolytic solution functioning as a medium for charge and discharge reaction largely affects performance of the secondary battery. Thus, various studies have been made on the composition of the electrolytic solution. Specifically, to improve cycle characteristics, safety and the like, a cyclic sulfonic ester compound such as a cyclic condensation product of hydroxymethanesulfonic acid is used (for example, see Japanese Unexamined Patent Application Publication No. 2005-228631). To improve thermal stability, a cyclic or chain dihalogendicarbonyl compound obtained by dehydrating and condensing dicarboxylic acid and alcohol such as dimethyldifluoromalonate is used (for example, see Japanese Unexamined Patent Application Publication No. 2002-124263).

### SUMMARY

In these years, the high performance and the multifunctions of the electronic devices are increasingly developed, and the electric power consumption thereof tends to be increased. Thus, charge and discharge of the secondary battery are frequently repeated, and the cycle characteristics and the storage characteristics are easily lowered. Accordingly, further improvement of the cycle characteristics and the storage characteristics of the secondary battery has been aspired.

In view of the foregoing disadvantage, in the application, it is desirable to provide a cyclic polyester capable of improving the cycle characteristics and the storage characteristics, an electrolytic solution for a secondary battery, a secondary, an electric power tool, an electrical vehicle, and an electric power storage system.

According to an embodiment, there is provided an electrolytic solution for a secondary battery containing a nonaqueous solvent and an electrolyte salt. The nonaqueous solvent contains cyclic polyester obtained by dehydrating and condensing two or more divalent carboxylic acid and one or more divalent alcohol. According to an embodiment, there is provided a secondary battery including a cathode, an anode, and an electrolytic solution. The electrolytic solution has a composition similar to that of the electrolytic solution for a secondary battery of the embodiment.

“Divalent carboxylic acid” is a compound having two carboxyl groups (—COOH). “Divalent alcohol” is a compound having two hydroxyl groups (—OH).

“Cyclic polyester” is a cyclic compound in which divalent carboxylic acid and divalent alcohol are linked to each other in a state of chain through ester bond (—C(═O)—O—) by the foregoing dehydration and condensation, and one loop (ring) is formed as a whole. The cyclic polyester may contain acid anhydride bond (—C(═O)—O—C(═O)—) obtained by dehydrating and condensing each divalent carboxylic acid together with the ester bond.

According to an embodiment, there is provided an electric power tool, an electrical vehicle, and an electric power storage system mounting a secondary battery. The secondary battery has a structure similar to that of the foregoing secondary battery of the embodiment.

According to an embodiment, there is provided a cyclic polyester expressed by Formula 1.

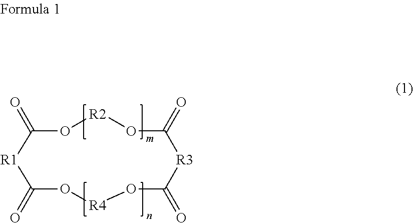

In the formula, R1 to R4 are a divalent organic group, and m and n are one of integer numbers 0 to 3. m and n satisfy m+n≧1.

According to the electrolytic solution for a secondary battery of the embodiment, since the nonaqueous solvent contains the cyclic polyester, chemical stability is improved. Thus, according to the secondary battery using the electrolytic solution for a secondary battery of the embodiment, decomposition reaction of the electrolytic solution at the time of charge and discharge is inhibited, and therefore the cycle characteristics and the storage characteristics are able to be improved. Further, according to the electric power tool, the electrical vehicle, and the electric power storage system using the secondary battery of the embodiment, characteristics such as the foregoing cycle characteristics are able to be improved.

The cyclic polyester of the embodiment has the structure shown in Formula 1. Thus, in the case where the cyclic polyester is used as a nonaqueous solvent or the like of an electrolytic solution for a secondary battery, the chemical stability thereof is able to be improved.

Additional features and advantages are described herein, and will be apparent from the following Detailed Description and the figures.

### BRIEF DESCRIPTION OF THE FIGURES

FIG. 1 is a cross sectional view illustrating a structure of a cylindrical type secondary battery using cyclic polyester according to an embodiment.

FIG. 2 is a cross sectional view illustrating a structure of a spirally wound electrode body illustrated in FIG. 1.

FIG. 3 is a cross sectional view schematically illustrating a structure of the anode.

FIG. 4 is a cross sectional view schematically illustrating another structure of the anode.

FIGS. 5A and 5B are an SEM photograph illustrating a cross sectional structure of the anode and a schematic drawing thereof.

FIGS. 6A and 6B are an SEM photograph illustrating another cross sectional structure of the anode and a schematic drawing thereof.

FIG. 7 is an exploded perspective view illustrating a structure of a laminated film type secondary battery using the cyclic polyester of the embodiment.

FIG. 8 is a cross sectional view taken along line VIII-VIII of the spirally wound electrode body illustrated in FIG. 7.

FIG. 9 is a diagram illustrating an analytical result of a SnCoC-containing material by XPS.

### DETAILED DESCRIPTION

Embodiments of the present application will be described below in detail with reference to the drawings.

A description will be hereinafter given in detail of an embodiment with reference to the drawings. The description will be given in the following order.

1. Cyclic polyester

2. Electrolytic solution for a secondary battery and a secondary battery

2-1. Lithium ion secondary battery (cylindrical type)

2-2. Lithium ion secondary battery (laminated film type)

2-3. Lithium metal secondary battery (cylindrical type and laminated film type)

3. Application of the secondary battery

1. Cyclic Polyester

Cyclic polyester of an embodiment is obtained by dehydrating and condensing two or more divalent carboxylic acid and one or more divalent alcohol (hereinafter simply referred to as “cyclic polyester.”) That is, the cyclic polyester is a polycondensation product of the divalent carboxylic acid and the divalent alcohol, and contains two or more ester bonds in the main chain. In the case where the cyclic polyester is contained in an electrolytic solution as a nonaqueous solvent, chemical stability of the electrolytic solution is able to be improved. The cyclic polyester is used as a nonaqueous solvent for, for example, an electrolytic solution of an electrochemical device such as a secondary battery.

The two or more divalent carboxylic acid may be the same type, or may be different from each other. The type of the divalent carboxylic acid is not particularly limited as long as the divalent carboxylic acid has two carboxyl groups. That is, any type is adopted as the type of divalent group (central group) that is bonded to two carboxyl groups (that is, the type of divalent group (central group) that is located between two carboxyl groups).

Specially, the central group of the divalent carboxylic acid is preferably an organic group, and is more preferably a hydrocarbon group or a halogenated group thereof, since thereby the divalent carboxylic acid is able to be easily synthesized. “Halogenated group” means a group obtained by substituting at least some hydrogen in the hydrocarbon group with halogen, and such definition is hereinafter similarly applied. Examples of halogen group include a fluorine group, a chlorine group, and a bromine group. Other group may be used as the halogen group. Examples of hydrocarbon group or halogenated hydrocarbon group include an alkylene group, an alkenylene group, an alkynylene group, an arylene group, a cycloalkylene group, and a halogenated group thereof.

The central group of the divalent carboxylic acid may have one or more other functional groups. Examples of such a functional group include a carbonyl group, an amino group, a hydroxyl group, a cyano group, a nitro group, an isocyanato group, an ether bond, an amide bond, and a sulfonic ester bond. However, the central group preferably does not have an alcoholic hydroxyl group, since thereby the cyclic polyester is able to be easily synthesized.

The divalent alcohol may be the same type, or may be different from each other as long as the number thereof is two or more. The type of the divalent alcohol is not particularly limited as long as the divalent alcohol has two hydroxyl groups. That is, any type is adopted as the type of divalent group (central group) that is bonded to two hydroxyl groups (that is, the type of divalent group (central group) that is located between two hydroxyl groups).

Specially, the divalent alcohol is preferably a compound expressed by HO—RO—H, HO—R—O—R—OH, HO—R—O—R—O—R—OH or the like, since thereby the cyclic polyester is able to be easily synthesized. Details of R as a divalent group are similar to those explained for the central group of the divalent carboxylic acid, except that a carboxyl group is not contained. In this case, the central group of the divalent alcohol is a group in which —R— and —O— are alternately arranged and —R— is located in both ends. The number of —R— and —O— may be a given number.

Thus, the foregoing cyclic polyester that is the polycondensation product of the divalent carboxylic acid and the divalent alcohol may have any other functional group, as long as one loop (ring) is formed as a whole.

Examples of cyclic polyester include a polycondensation product of two divalent carboxylic acid and one divalent alcohol, a polycondensation product of two divalent carboxylic acid and two divalent alcohol, a polycondensation product of three divalent carboxylic acid and one divalent alcohol, a polycondensation product of three divalent carboxylic acid and two divalent alcohol, a polycondensation product of three divalent carboxylic acid and three divalent alcohol, and a polycondensation product of four or more divalent carboxylic acid and one or more divalent alcohol.

Specially, the cyclic polyester is preferably a polycondensation product of two to four both inclusive divalent carboxylic acid and one to four both inclusive divalent alcohol, and is more preferably a polycondensation product of two divalent carboxylic acid and one or two divalent alcohol, since thereby chemical stability of the electrolytic solution is able to be further improved. Specifically, the cyclic polyester is preferably a cyclic compound expressed by Formula 1.

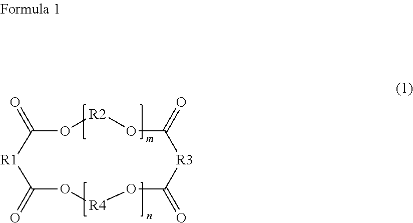

In the formula, R1 to R4 are a divalent organic group, and m and n are one of integer numbers 0 to 3. m and n satisfy m+n≧1.

R1 to R4 may be the same group, or may be a group different from each other. m and n may be the same or may be different from each other, as long as m and n satisfy m+n≧1. R1 and R3 are a group contained in the divalent carboxylic acid to form the cyclic polyester, and R2 and R4 are a group contained in the divalent alcohol to form the cyclic polyester.

The divalent organic group is not particularly limited as long as the divalent organic group contained carbon as an element. However, as the divalent organic group, as described above, a divalent organic group not containing a hydroxyl group is preferable for R1 and R3, and a divalent organic group not containing a carboxyl group is preferable for R2 and R4. Further, as the divalent organic group, an atomic type bonded to an adjacent carbonyl group (—C(═O)—) is preferably carbon for R1 and R3, and an atomic type bonded to an adjacent oxygen atom is preferably carbon for R2 and R4. In any case, the cyclic polyester is easily synthesized, and chemical stability of the compound is improved.

Specially as a divalent organic group, a carbon hydride group or a halogenated group thereof is preferable. More specifically, as a divalent organic group, a carbon hydride group such as an alkylene group, an alkenylene group, an alkynylene group, a cycloalkylene group, and an arylene group or a halogenated group thereof (halogenated carbon hydride group) and the like are preferable, since thereby chemical stability of the electrolytic solution is further improved. For the carbon hydride group and the halogenated carbon hydride group, though the carbon number is not particularly limited, the carbon number is preferably from 1 to 20 both inclusive, is more preferably from 1 to 10 both inclusive, and is, in particular, preferably from 1 to 3 both inclusive, since thereby solubility and compatibility with respect to a nonaqueous solvent are further improved, and chemical stability of the electrolytic solution is further improved. For the halogenated group, though halogen type is not particularly limited, fluorine is specially preferable, since thereby chemical stability of the electrolytic solution is further improved than in the case that halogen type is chlorine or the like.

As R1 to R4, specially, an alkylene group having carbon number from 1 to 20 both inclusive or a halogenated alkylene group having carbon number from 1 to 20 both inclusive is preferable. In this case, the carbon number is more preferably from 1 to 10 both inclusive, and is, in particular, preferably from 1 to 3 both inclusive, since thereby solubility and compatibility with respect to a nonaqueous solvent are further improved, and chemical stability of the electrolytic solution is further improved.

m and n are one of integer numbers 0 to 3, and m and n satisfy m+n≧1 for the following reason. That is, in this case, solubility and compatibility with respect to a nonaqueous solvent are improved, and thus chemical stability of the electrolytic solution is further improved. Specially, both m and n are preferably 1 or more, and are in particular, preferably 1, since thereby higher effect is able to be obtained.

Examples of the cyclic compound shown in Formula 1 include compounds expressed by Formula (1-1) to Formula (1-24), since thereby chemical stability of the electrolytic solution or the like is able to be sufficiently improved. Specially, the compound shown in Formula (1-1) or the compound shown in Formula (1-20) is preferable, since such a compound is easily available, and is able to be stably mixed with various nonaqueous solvents and the like.

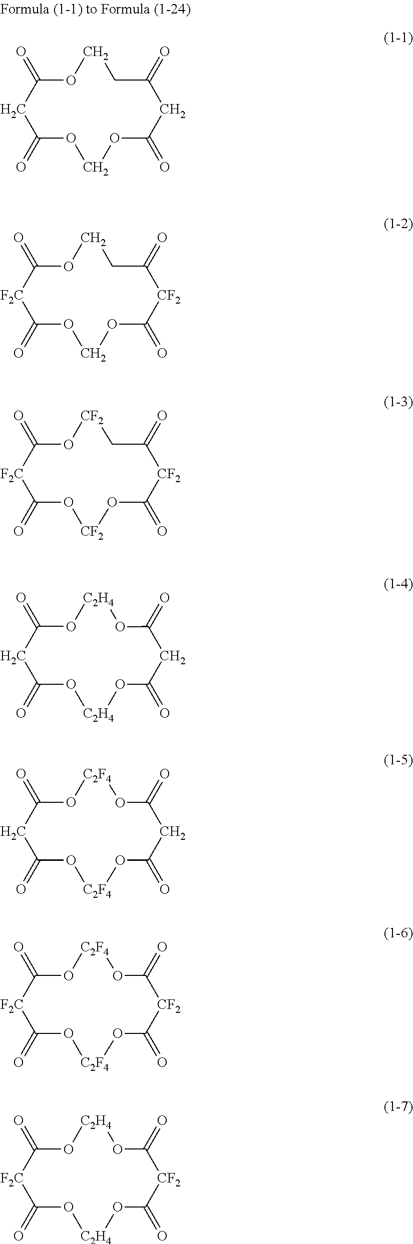

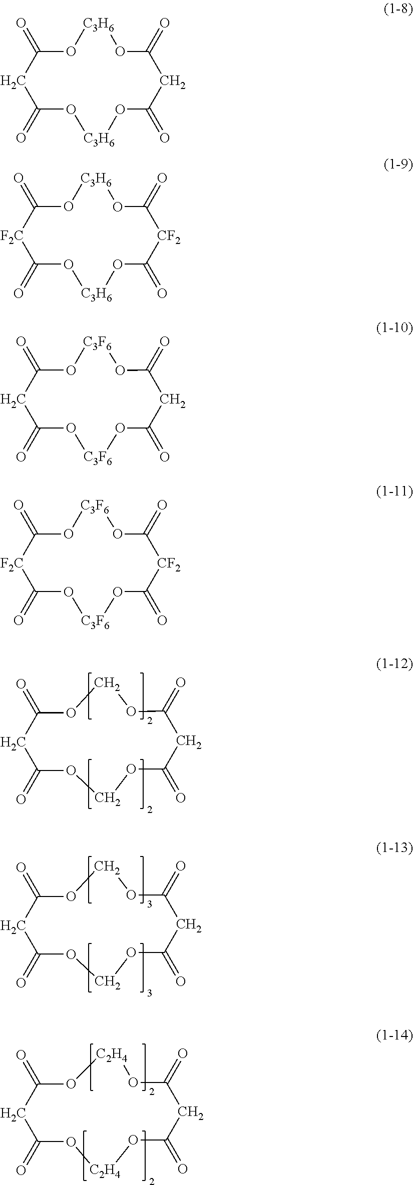

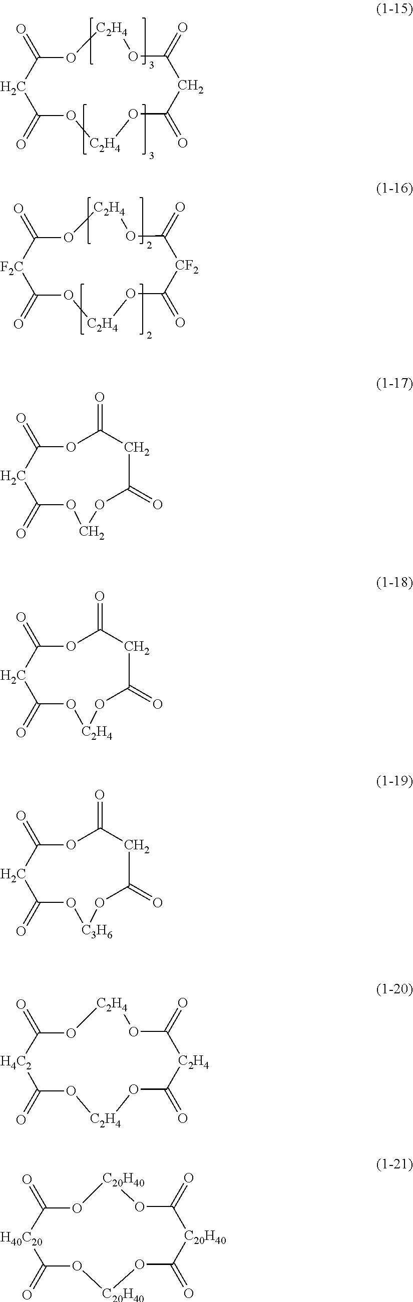

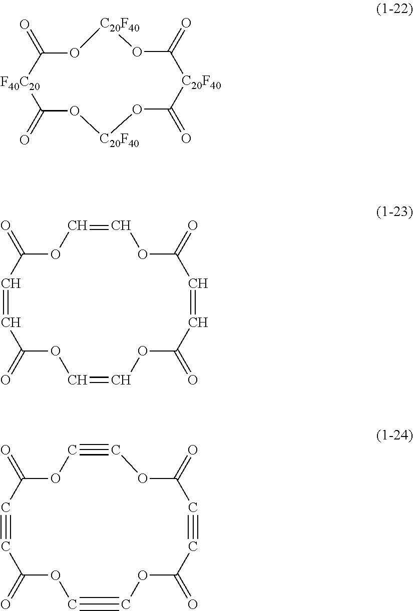

It is needless to say that the specific examples of the cyclic compound shown in Formula 1 is not limited to the compounds shown in Formula (1-1) to Formula (1-24), as long as a compound has the structure shown in Formula 1.

According to the cyclic polyester, compared to other type of cyclic polyester and a chain polyester, in the case where the cyclic polyester is used as a nonaqueous solvent of an electrolytic solution for an electrochemical device such as a secondary battery, chemical stability of the electrolytic solution is able to be improved. Examples of other type of cyclic polyester include a cyclic compound shown in Formula 13 obtained by dehydrating and condensing one divalent carboxylic acid and one divalent alcohol. Further, examples of the chain polyester include a chain compound expressed by Formula 14. Accordingly, decomposition reaction of the electrolytic solution at the time of electrode reaction is inhibited, and thereby the cyclic polyester is able to contribute to improve performance of an electrochemical device.

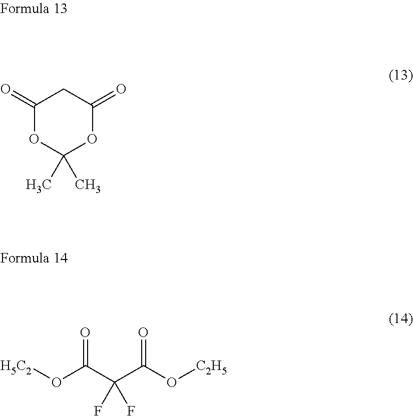

2. Electrolytic Solution for a Secondary Battery and a Secondary Battery

Next, a description will be given of application examples of the foregoing cyclic polyester. A lithium secondary battery is herein taken as an example of electrochemical devices. The cyclic polyester is used for an electrolytic solution for a lithium secondary battery (hereinafter simply referred to as “electrolytic solution”) and a lithium secondary battery as follows.

2-1. Lithium Ion Secondary Battery (Cylindrical Type)

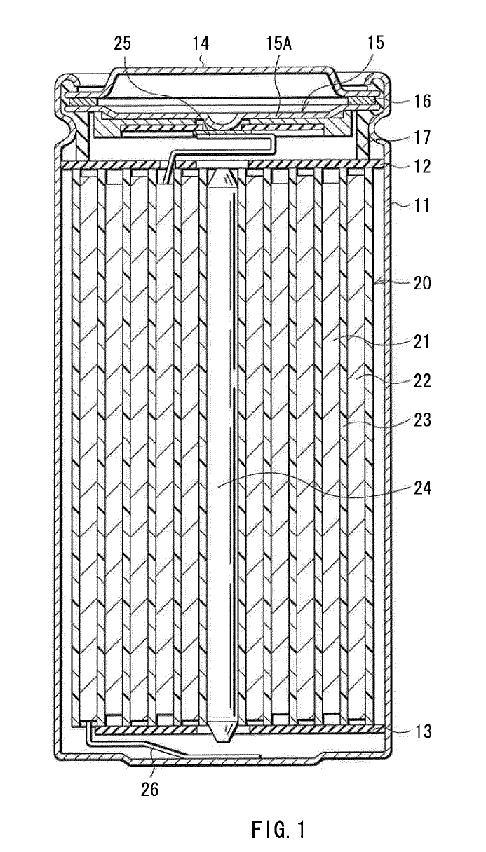

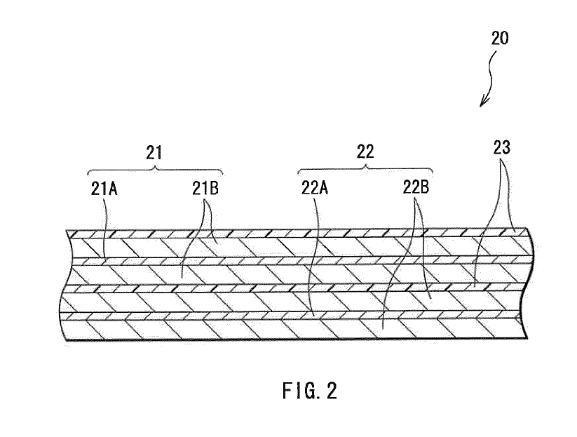

FIG. 1 and FIG. 2 illustrate a cross sectional structure of a lithium ion secondary battery (cylindrical type). FIG. 2 illustrates an enlarged part of a spirally wound electrode body 20 illustrated in FIG. 1. In the lithium ion secondary battery, the anode capacity is expressed by insertion and extraction of lithium ion.

Whole Structure of the Secondary Battery

The secondary battery mainly contains a spirally wound electrode body 20 and a pair of insulating plates 12 and 13 inside a battery can 11 in the shape of an approximately hollow cylinder. The spirally wound electrode body 20 is a spirally wound laminated body in which a cathode 21 and an anode 22 are layered with a separator 23 in between and are spirally wound.

The battery can 11 has a hollow structure in which one end of the battery can 11 is closed and the other end thereof is opened. The battery can 11 is made of, for example, iron (Fe), aluminum (Al), an alloy thereof or the like. In the case where the battery can 11 is made of iron, for example, plating of nickel (Ni) or the like may be provided on the surface of the battery can 11. The pair of insulating plates 12 and 13 is arranged to sandwich the spirally wound electrode body 20 in between from the upper and the lower sides, and to extend perpendicularly to the spirally wound periphery face.

At the open end of the battery can 11, a battery cover 14, a safety valve mechanism 15, and a PTC (Positive Temperature Coefficient) device 16 are attached by being caulked with a gasket 17. Inside of the battery can 11 is hermetically sealed. The battery cover 14 is made of, for example, a material similar to that of the battery can 11. The safety valve mechanism 15 and the PTC device 16 are provided inside the battery cover 14. The safety valve mechanism 15 is electrically connected to the battery cover 14 through the PTC device 16. In the safety valve mechanism 15, in the case where the internal pressure becomes a certain level or more by internal short circuit, external heating or the like, a disk plate 15A flips to cut the electric connection between the battery cover 14 and the spirally wound electrode body 20. As temperature rises, the PTC device 16 increases the resistance and thereby abnormal heat generation resulting from a large current is prevented. The gasket 17 is made of, for example, an insulating material. The surface of the gasket 17 may be coated with, for example, asphalt.

In the center of the spirally wound electrode body 20, for example, a center pin 24 may be inserted. A cathode lead 25 made of a conductive material such as aluminum is connected to the cathode 21, and an anode lead 26 made of a conductive material such as nickel is connected to the anode 22. The cathode lead 25 is electrically connected to the battery cover 14 by, for example, being welded to the safety valve mechanism 15. The anode lead 26 is, for example, welded to the battery can 11 and thereby electrically connected to the battery can 11.

Cathode

In the cathode 21, for example, a cathode active material layer 21B is provided on both faces of a cathode current collector 21A. However, the cathode active material layer 21B may be provided only on a single face of the cathode current collector 21A.

The cathode current collector 21A is made of, for example, a conductive material such as aluminum, nickel, and stainless steel.

The cathode active material layer 21B contains, as a cathode active material, one or more cathode materials capable of inserting and extracting lithium ions. According to needs, the cathode active material layer 21B may contain other material such as a cathode binder and a cathode electrical conductor.

As the cathode material, a lithium-containing compound is preferable, since thereby a high energy density is able to be obtained. Examples of the lithium-containing compounds include a composite oxide having lithium (Li) and a transition metal element as an element and a phosphate compound containing lithium and a transition metal element as an element. Specially, a compound containing at least one of cobalt (Co), nickel, manganese (Mn), and iron as a transition metal element is preferable, since thereby a higher voltage is obtained. The chemical formula thereof is expressed by, for example, LiₓM1O₂ or Li_{y}M2PO₄. In the formula, M1 and M2 represent one or more transition metal elements. Values of x and y vary according to the charge and discharge state, and are generally in the range of 0.05≦x≦1.10 and 0.05≦y≦1.10.

Examples of composite oxides containing lithium and a transition metal element include a lithium-cobalt composite oxide (LiₓCoO₂), a lithium-nickel composite oxide (LiₓNiO₂), and a lithium-nickel composite oxide expressed by Formula 15. Examples of phosphate compounds containing lithium and a transition metal element include lithium-iron phosphate compound (LiFePO₄) and a lithium-iron-manganese phosphate compound (LiFe₁₋ᵤMnᵤPO₄ (u<1)), since thereby a high battery capacity is obtained and superior cycle characteristics are obtained.

LiNi₁₋ₓMₓO₂ Formula 15

In the formula, M is at least one of cobalt, manganese, iron, aluminum, vanadium (V), tin, magnesium (Mg), titanium (Ti), strontium (Sr), calcium (Ca), zirconium (Zr), molybdenum (Mo), technetium (Tc), ruthenium (Ru), tantalum (Ta), tungsten (W), rhenium (Re), ytterbium (Y), copper (Cu), zinc (Zn), barium (Ba), boron (B), chromium (Cr), silicon, gallium (Ga), phosphorus (P), antimony (Sb), and niobium (Nb). x is in the range of 0.005<x<0.5.

In addition, examples of cathode materials include an oxide, a disulfide, a chalcogenide, and a conductive polymer. Examples of oxides include titanium oxide, vanadium oxide, and manganese dioxide. Examples of disulfide include titanium disulfide and molybdenum sulfide. Examples of chalcogenide include niobium selenide. Examples of conductive polymer include sulfur, polyaniline, and polythiophene.

It is needless to say that the cathode material may be a material other than the foregoing materials. Further, two or more of the foregoing cathode materials may be used by mixture arbitrarily.

Examples of cathode binders include a synthetic rubber such as styrene butadiene rubber, fluorinated rubber, and ethylene propylene diene; and a polymer material such as polyvinylidene fluoride. One thereof may be used singly, or a plurality thereof may be used by mixture.

Examples of cathode electrical conductors include a carbon material such as graphite, carbon black, acetylene black, and Ketjen black. Such a carbon material may be used singly, or a plurality thereof may be used by mixture. The cathode electrical conductor may be a metal material, a conductive polymer or the like as long as a material has the electric conductivity.

Anode

In the anode 22, for example, an anode active material layer 22B is provided on both faces of an anode current collector 22A. However, the anode active material layer 22B may be provided only on a single face of the anode current collector 22A.

The anode current collector 22A is made of, for example, a conductive material such as copper, nickel, and stainless steel. The surface of the anode current collector 22A is preferably roughened. Thereby, due to the so-called anchor effect, the contact characteristics between the anode current collector 22A and the anode active material layer 22B are improved. In this case, it is enough that at least the surface of the anode current collector 22A in the area opposed to the anode active material layer 22B is roughened. Examples of roughening methods include a method of forming fine particles by electrolytic treatment. The electrolytic treatment is a method of providing concavity and convexity by forming fine particles on the surface of the anode current collector 22A by electrolytic method in an electrolytic bath. A copper foil formed by electrolytic method is generally called “electrolytic copper foil.”

The anode active material layer 22B contains one or more anode materials capable of inserting and extracting lithium ions as an anode active material, and may also contain other material such as an anode binder and an anode electrical conductor according to needs. Details of the anode binder and the anode electrical conductor are, for example, respectively similar to those of the cathode binder and the cathode electrical conductor. In the anode active material layer 22B, the chargeable capacity of the anode material is preferably larger than the discharge capacity of the cathode 21 in order to prevent, for example, unintentional precipitation of lithium metal at the time of charge and discharge.

Examples of anode materials include a carbon material. In the carbon material, crystal structure change associated with insertion and extraction of lithium ions is extremely small. Thus, the carbon material provides a high energy density and superior cycle characteristics, and functions as an anode electrical conductor as well. Examples of carbon materials include graphitizable carbon, non-graphitizable carbon in which the spacing of (002) plane is 0.37 nm or more, and graphite in which the spacing of (002) plane is 0.34 nm or less. More specifically, examples of carbon materials include pyrolytic carbon, coke, glassy carbon fiber, an organic polymer compound fired body, activated carbon, and carbon black. The coke includes pitch coke, needle coke, and petroleum coke. The organic polymer compound fired body is obtained by firing a phenol resin, a furan resin or the like at an appropriate temperature. The shape of the carbon material may be any of a fibrous shape, a spherical shape, a granular shape, and a scale-like shape.

Examples of anode materials include a material (metal material) containing at least one of metal elements and metalloid elements as an element. Such an anode material is preferably used, since a high energy density is able to be thereby obtained. Such a metal material may be a simple substance, an alloy, or a compound of a metal element or a metalloid element, may be two or more thereof, or may have one or more phases thereof at least in part. In the application, “alloy” includes an alloy containing one or more metal elements and one or more metalloid elements, in addition to an alloy composed of two or more metal elements. Further, “alloy” may contain a nonmetallic element. The structure thereof includes a solid solution, a eutectic crystal (eutectic mixture), an intermetallic compound, and a structure in which two or more thereof coexist.

The foregoing metal element or the foregoing metalloid element is a metal element or a metalloid element capable of forming an alloy with lithium. Specifically, the foregoing metal element or the foregoing metalloid element is at least one of the following elements. That is, the foregoing metal element or the foregoing metalloid element is at least one of magnesium, boron, aluminum, gallium, indium (In), silicon, germanium (Ge), tin, lead (Pb), bismuth (Bi), cadmium (Cd), silver (Ag), zinc, hafnium (Hf), zirconium, yttrium, palladium (Pd), and platinum (Pt). Specially, at least one of silicon and tin is preferably used. Silicon and tin have the high ability to insert and extract lithium ion, and thus are able to provide a high energy density.

A material containing at least one of silicon and tin may be, for example, a simple substance, an alloy, or a compound of silicon or tin; two or more thereof; or a material having one or more phases thereof at least in part.

Examples of alloys of silicon include an alloy containing at least one of the following elements as an element other than silicon. Such an element other than silicon is tin, nickel, copper, iron, cobalt, manganese, zinc, indium, silver, titanium, germanium, bismuth, antimony, and chromium. Examples of compounds of silicon include a compound containing oxygen or carbon as an element other than silicon. The compounds of silicon may contain one or more of the elements described for the alloys of silicon as an element other than silicon.

Examples of an alloy or a compound of silicon include SiB₄, SiB₆, Mg₂Si, Ni₂Si, TiSi₂, MoSi₂, CoSi₂, NiSi₂, CaSi₂, CrSi₂, Cu₅Si, and FeSi₂. Further, examples thereof include MnSi₂, NbSi₂, TaSi₂, VSi₂, WSi₂, ZnSi₂, SiC, Si₃N₄, Si₂N₂O, SiOᵥ (0<v≦2), and LiSiO.

Examples of alloys of tin include an alloy containing at least one of the following elements as an element other than tin. Such an element is silicon, nickel, copper, iron, cobalt, manganese, zinc, indium, silver, titanium, germanium, bismuth, antimony, or chromium. Examples of compounds of tin include a compound containing oxygen or carbon. The compounds of tin may contain, for example, one or more elements described for the alloys of tin as an element other than tin. Examples of alloys or compounds of tin include SnOw (0<w≦2), SnSiO3, LiSnO, and Mg2Sn.

In particular, as a material containing silicon (silicon-containing material), for example, the simple substance of silicon is preferable, since a high battery capacity, superior cycle characteristics and the like are thereby obtained. “Simple substance” only means a general simple substance (may contain a slight amount of impurity), but does not necessarily mean a substance with purity of 100%.

Further, as a material containing tin (tin-containing material), for example, a material containing a second element and a third element in addition to tin as a first element is preferable. The second element is, for example, at least one of the following elements. That is, the second element is at least one of cobalt, iron, magnesium, titanium, vanadium, chromium, manganese, nickel, copper, zinc, gallium, zirconium, niobium, molybdenum, silver, indium, cerium (Ce), hafnium, tantalum, tungsten, bismuth, and silicon. The third element is, for example, at least one of boron, carbon, aluminum, and phosphorus. In the case where the second element and the third element are contained, a high battery capacity, superior cycle characteristics and the like are obtained.

Specially, a material containing tin, cobalt, and carbon (SnCoC-containing material) is preferable. As the composition of the SnCoC-containing material, for example, the carbon content is from 9.9 mass % to 29.7 mass % both inclusive, and the ratio of tin and cobalt contents (Co/(Sn+Co)) is from 20 mass % to 70 mass % both inclusive, since a high energy density is obtained in such a composition range.

It is preferable that the SnCoC-containing material has a phase containing tin, cobalt, and carbon. Such a phase preferably has a low crystalline structure or an amorphous structure. The phase is a reaction phase capable of being reacted with lithium. Due to existence of the reaction phase, superior characteristics are able to be obtained. The half-width of the diffraction peak obtained by X-ray diffraction of the phase is preferably 1.0 deg or more based on diffraction angle of 2θ in the case where CuKα ray is used as a specific X ray, and the trace speed is 1 deg/min. Thereby, lithium ions are more smoothly inserted and extracted, and reactivity with the electrolytic solution or the like is decreased. In some cases, the SnCoC-containing material has a phase containing a simple substance or part of the respective elements in addition to the low crystalline or amorphous phase.

Whether or not the diffraction peak obtained by X-ray diffraction corresponds to the reaction phase capable of being reacted with lithium is able to be easily determined by comparison between X-ray diffraction charts before and after electrochemical reaction with lithium. For example, if the position of the diffraction peak after electrochemical reaction with lithium is changed from the position of the diffraction peak before electrochemical reaction with lithium, the obtained diffraction peak corresponds to the reaction phase capable of being reacted with lithium. In this case, for example, the diffraction peak of the low crystalline or amorphous reaction phase is observed in the range of 2θ=20 to 50 deg. Such a reaction phase contains the foregoing element, and the low crystalline or amorphous structure may result from existence of carbon.

In the SnCoC-containing material, at least part of carbon as an element is preferably bonded to a metal element or a metalloid element as other element, since thereby cohesion or crystallization of tin or the like is inhibited. The bonding state of elements is able to be checked by, for example, X-ray Photoelectron Spectroscopy (XPS). In a commercially available apparatus, for example, as a soft X ray, Al—Kα ray, Mg—Kα ray or the like is used. In the case where at least part of carbon is bonded to a metal element, a metalloid element or the like, the peak of a synthetic wave of 1s orbit of carbon (C1s) is observed in a region lower than 284.5 eV. In the apparatus, energy calibration is made so that the peak of 4f orbit of gold atom (Au4f) is obtained in 84.0 eV. At this time, in general, since surface contamination carbon exists on the material surface, the peak of C1s of the surface contamination carbon is regarded as 284.8 eV, which is used as the energy standard. In XPS measurement, the waveform of the peak of C1s is obtained as a form including the peak of the surface contamination carbon and the peak of carbon in the SnCoC-containing material. Thus, for example, analysis is made by using commercially available software to separate both peaks from each other. In the waveform analysis, the position of a main peak existing on the lowest bound energy side is the energy standard (284.8 eV).

The SnCoC-containing material may further contain other element according to needs. Examples of other elements include at least one of silicon, iron, nickel, chromium, indium, niobium, germanium, titanium, molybdenum, aluminum, phosphorus, gallium, and bismuth.

In addition to the SnCoC-containing material, a material containing tin, cobalt, iron, and carbon (SnCoFeC-containing material) is also preferable. The composition of the SnCoFeC-containing material is able to be arbitrarily set. For example, a composition in which the iron content is set small is as follows. That is, the carbon content is from 9.9 mass % to 29.7 mass % both inclusive, the iron content is from 0.3 mass % to 5.9 mass % both inclusive, and the ratio of contents of tin and cobalt (Co/(Sn+Co)) is from 30 mass % to 70 mass % both inclusive. Further, for example, a composition in which the iron content is set large is as follows. That is, the carbon content is from 11.9 mass % to 29.7 mass % both inclusive, the ratio of contents of tin, cobalt, and iron ((Co+Fe)/(Sn+Co+Fe)) is from 26.4 mass % to 48.5 mass % both inclusive, and the ratio of contents of cobalt and iron (Co/(Co+Fe)) is from 9.9 mass % to 79.5 mass % both inclusive. In such a composition range, a high energy density is obtained. The physical property and the like (half-width) of the SnCoFeC-containing material are similar to those of the foregoing SnCoC-containing material.

Further, examples of other anode materials include a metal oxide and a polymer compound. The metal oxide is, for example, iron oxide, ruthenium oxide, molybdenum oxide or the like. The polymer compound is, for example, polyacetylene, polyaniline, polypyrrole or the like.

It is needless to say that the anode material may be a material other than the foregoing materials. Further, two or more of the anode active materials may be used by mixture arbitrarily.

The anode active material layer 22B is formed by, for example, coating method, vapor-phase deposition method, liquid-phase deposition method, spraying method, firing method (sintering method), or a combination of two or more of these methods. Coating method is a method in which, for example, a particulate anode active material is mixed with a binder or the like, the mixture is dispersed in a solvent, and the anode current collector is coated with the resultant. Examples of vapor-phase deposition methods include physical deposition method and chemical deposition method. Specifically, examples thereof include vacuum evaporation method, sputtering method, ion plating method, laser ablation method, thermal CVD (Chemical Vapor Deposition) method, and plasma CVD method. Examples of liquid-phase deposition methods include electrolytic plating method and electroless plating method. Spraying method is a method in which the anode active material is sprayed in a fused state or a semi-fused state. Firing method is, for example, a method in which after the anode current collector is coated by a procedure similar to that of coating method, heat treatment is provided at a temperature higher than the melting point of the binder or the like. As firing method, a known technique is able to be used. Examples thereof include atmosphere firing method, reactive firing method, and hot press firing method.

The anode active material is composed of, for example, a plurality of particles. In this case, the anode active material layer 22B contains a plurality of particulate anode active materials (hereinafter simply referred to as “anode active material particles”). The anode active material particles are formed by, for example, vapor-phase deposition method or the like. However, the anode active material particles may be formed by a method other than vapor-phase deposition method.

In the case where the anode active material particles are formed by using a deposition method such as vapor-phase deposition method, the anode active material particles may have a single layer structure formed by a single deposition step or may have a multilayer structure formed by a plurality of deposition steps. However, in the case where evaporation method or the like associated with high heat is used at the time of deposition, the anode active material particles preferably have a multilayer structure. In this case, since the deposition step of the anode material is divided into several steps (a plurality of thin layers of the anode material are sequentially formed and deposited), time that the anode current collector 22A is exposed at high heat is shortened compared to a case that the deposition is performed in a single deposition step. Thereby, the anode current collector 22A is less likely to be subject to thermal damage.

It is preferable that the anode active material particles are grown, for example, in the thickness direction of the anode active material layer 22B from the surface of the anode current collector 22A, and the anode active material particles are linked to the surface of the anode current collector 22A at the root thereof. Thereby, expansion and shrinkage of the anode active material layer 22B are inhibited at the time of charge and discharge. Further, it is preferable that the anode active material particles are formed by vapor-phase deposition method, liquid-phase deposition method, spraying method, firing method or the like, and at least part of the interface with the anode current collector 22A is alloyed. In this case, at the interface in between, the element of the anode current collector 22A may be diffused in the anode active material particles; or the element of the anode active material particles may be diffused in the anode current collector 22A; or the respective elements may be diffused in each other.

In particular, the anode active material layer 22B preferably contains an oxide-containing film to cover the surface of the anode active material particles (region to be contacted with the electrolytic solution if the oxide-containing film is not provided). In this case, the oxide-containing film functions as a protective film for the electrolytic solution, and accordingly decomposition reaction of the electrolytic solution is inhibited at the time of charge and discharge. Thereby, the cycle characteristics, the storage characteristics and the like are improved. The oxide-containing film may cover the entire surface of the anode active material particles, or may cover only part thereof. Specially, the oxide-containing film preferably covers the entire surface of the anode active material particles, since thereby decomposition reaction of the electrolytic solution is more inhibited.

The oxide-containing film contains, for example, at least one of a silicon oxide, a germanium oxide, and a tin oxide. Specially, the oxide-containing film preferably contains the silicon oxide, since thereby the oxide-containing film easily covers the entire surface of the anode active material particles, and superior protective action is thereby obtained. It is needless to say that the oxide-containing film may contain an oxide other than the foregoing oxides.

The oxide-containing film is formed by, for example, vapor-phase deposition method, liquid-phase deposition method or the like. Specially, the oxide-containing film is preferably formed by liquid-phase deposition method, since thereby the oxide-containing film easily covers a wide range of the surface of the anode active material particles. Examples of liquid-phase deposition methods include liquid-phase precipitation method, sol gel method, coating method, and dip coating method. Specially, liquid-phase precipitation method, sol gel method, or dip coating method is preferable, and liquid-phase precipitation method is more preferable, since thereby higher effect is obtained. The oxide-containing film may be formed by a single formation method out of the foregoing formation methods, or may be formed by two or more formation methods thereof.

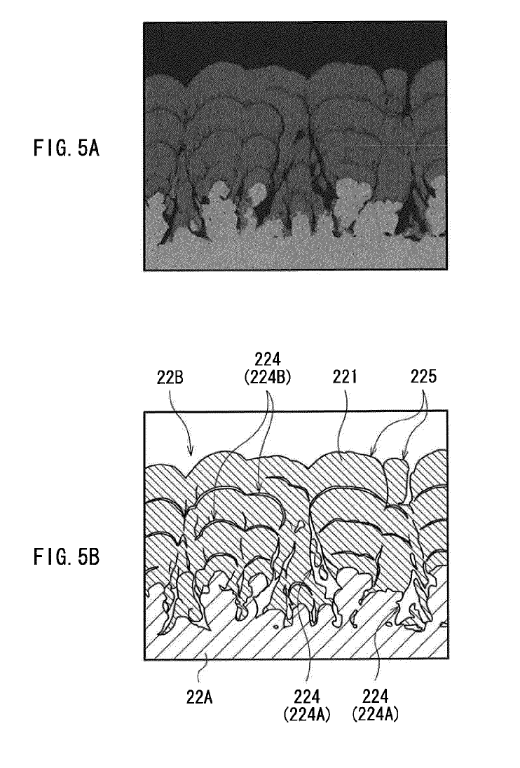

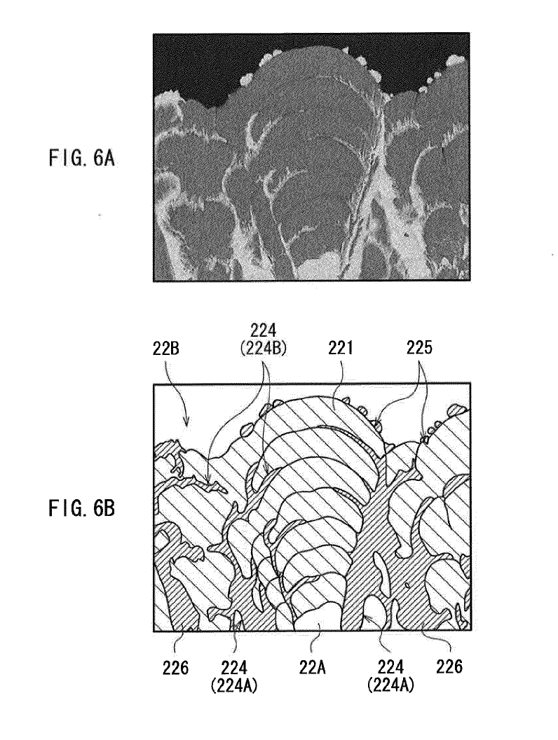

Further, the anode active material layer 22B preferably contains a metal material containing a metal element not being alloyed with lithium as an element (hereinafter simply referred to as “metal material”) in a gap inside the anode active material layer 22B according to needs. Thereby, the plurality of anode active materials are bound to each other with the metal material in between. In addition, expansion and shrinkage of the anode active material layer 22B are inhibited. Thereby, the cycle characteristics, the storage characteristics and the like are improved. For the details of “gap inside the anode active material layer 22B,” a description will be given later (refer to FIGS. 5A to 6B).

Examples of the foregoing metal elements include at least one selected from the group consisting of iron, cobalt, nickel, zinc, and copper. Specially, cobalt is preferable, since thereby the metal material easily enters into the gap inside the anode active material layer 22B, and superior binding characteristics are obtained. It is needless to say that the metal element may be a metal element other than the foregoing metal elements. However, “metal material” herein is a comprehensive term, including not only a simple substance but also an alloy and a metal compound.

The metal material is formed by, for example, vapor-phase deposition method, liquid-phase deposition method or the like. Specially, the metal material is preferably formed by liquid-phase deposition method, since thereby the metal material easily enters into the gap inside the anode active material layer 22B. Examples of liquid-phase deposition methods include electrolytic plating method and electroless plating method. Specially, electrolytic plating method is preferable, since thereby the metal material more easily enters into the foregoing gap, and the formation time thereof is shortened. The metal material may be formed by a single formation method out of the foregoing formation methods, or may be formed by two or more formation methods thereof.

The anode active material layer 22B may contain only one of the oxide-containing film and the metal material, or may contain both thereof. However, in order to further improve the cycle characteristics and the like, the anode active material layer 22B preferably contains both thereof. In the case where the anode active material layer 22B contains only one thereof, in order to further improve the cycle characteristics and the like, the anode active material layer 22B preferably contains the oxide-containing film. In the case where the anode active material layer 22B contains both the oxide-containing film and the metal material, it is possible to firstly form any thereof. However, in order to further improve the cycle characteristics and the like, the oxide-containing film is preferably formed first.

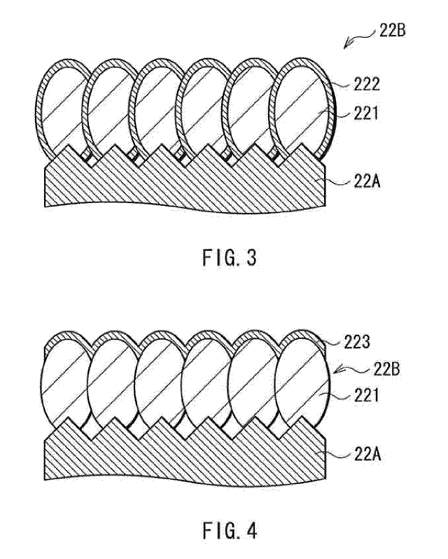

A description will be given of a detailed structure of the anode 22 with reference to FIG. 3 to FIG. 6B.

First, a description will be given of a case that the anode active material layer 22B contains the plurality of anode active material particles and the oxide-containing film. FIG. 3 and FIG. 4 schematically illustrate a cross sectional structure of the anode 22. A case that the anode active material particles have a single layer structure is herein illustrated.

In the case illustrated in FIG. 3, for example, if the anode material is deposited on the anode current collector 22A by vapor-phase deposition method such as evaporation method, a plurality of anode active material particles 221 are formed on the anode current collector 22A. In this case, if the surface of the anode current collector 22A is roughened and a plurality of projections (for example, fine particles formed by electrolytic treatment) exist on the surface, the anode active material particles 221 are grown for every projection described above in the thickness direction. Thus, the plurality of anode active material particles 221 are arranged on the surface of the anode current collector 22A, and are linked to the surface of the anode current collector 22A at the root thereof After that, for example, an oxide-containing film 222 is formed on the surface of the anode active material particles 221 by liquid-phase deposition method such as liquid-phase precipitation method. The oxide-containing film 222 covers almost entire surface of the anode active material particles 221. In this case, a wide range from the apex section of the anode active material particles 221 to the root thereof is covered. Such a wide range covering state is characteristics shown in the case where the oxide-containing film 222 is formed by liquid-phase deposition method. That is, in the case where the oxide containing film 222 is formed by using liquid-phase deposition method, covering action is applied not only to the apex section of the anode active material particles 221 but also to the root thereof, and thus the oxide-containing film 222 covers a section from the apex section of the anode active material particles 221 to the root thereof.

Meanwhile, in the case illustrated in FIG. 4, for example, after the plurality of anode active material particles 221 are formed by vapor-phase deposition method, an oxide-containing film 223 is formed similarly by vapor-phase deposition method. The oxide-containing film 223 covers only the apex section of the anode active material particles 221. Such a small range covering state is characteristics shown in the case where the oxide-containing film 223 is formed by vapor-phase deposition method. That is, in the case where the oxide containing film 223 is formed by vapor-phase deposition method, covering action is applied to the apex section of the anode active material particles 221 but not applied to the root thereof, and thus the oxide-containing film 223 does not cover the root thereof.

A description has been given of the case that the anode active material layer 22B is formed by vapor-phase deposition method with reference to FIG. 3. However, the same state is also applied if the anode active material layer 22B is formed by other formation method such as coating method and sintering method. In these cases, the oxide-containing film 222 is formed to cover almost entire surface of the plurality of anode active material particles.

Next, a description will be given of a case that the anode active material layer 22B contains the metal material together with the plurality of anode active material particles. FIGS. 5A to 6B illustrate an enlarged cross sectional structure of the anode 22. In FIGS. 5A to 6B, FIGS. 5A and 6A illustrate a Scanning Electron Microscope (SEM) photograph (secondary electron image), and FIGS. 5B and 6B illustrate a schematic drawing of the SEM image illustrated in FIG. 5A and FIG. 6A. In this case, FIGS. 5A to 6B illustrate a case that the plurality of anode active material particles 221 have a multilayer structure.

As illustrated in FIGS. 5A and 5B, in the case where the anode active material particles 221 have the multilayer structure, a plurality of gaps 224 are generated in the anode active material layer 22B due to the arrangement structure, the multilayer structure, and the surface structure of the anode active material particles 221. The gap 224 mainly includes two types of gaps 224A and 224B categorized according to the cause of generation. The gap 224A is a gap generated between adjacent anode active material particles 221. Meanwhile, the gap 224B is a gap generated between each layer of the anode active material particles 221.

On the exposed face (outermost surface) of the anode active material particle 221, a void 225 is generated in some cases. Since a fibrous minute projection (not illustrated) is formed on the surface of the anode active material particles 221, the void 225 is generated between the projections. The void 225 may be generated entirely over the exposed face of the anode active material particles 221, or may be generated in only part thereof. Since the foregoing fibrous projection is generated on the surface of the anode active material particles 221 every time the anode active material particle 221 is formed, the void 225 is generated between each layer in addition to on the exposed face of the anode active material particles 221 in some cases.

As illustrated in FIGS. 6A and 6B, the anode active material layer 22B has a metal material 226 in the gaps 224A and 224B. In this case, though only one of the gaps 224A and 224B may have the metal material 226, both the gaps 224A and 224B preferably have the metal material 226, since thereby higher effect is obtained.

The metal material 226 intrudes into the gap 224A between adjacent anode active material particles 221. More specifically, in the case where the anode active material particles 221 are formed by vapor-phase deposition method or the like, the anode active material particles 221 are grown for every projection existing on the surface of the anode current collector 22A as described above, and thus the gap 224A is generated between the adjacent anode active material particles 221. The gap 224A causes lowering of the binding characteristics of the anode active material layer 22B. Therefore, to improve the binding characteristics, the metal material 226 fills in the gap 224A. In this case, though it is enough that part of the gap 224A is filled therewith, the larger filling amount is preferable, since thereby the binding characteristics of the anode active material layer 22B are further improved. The filling amount of the metal material 226 is preferably 20% or more, more preferably 40% or more, and much more preferably 80% or more.

Further, the metal material 226 intrudes into the gap 224B in the anode active material particles 221. More specifically, in the case where the anode active material particles 221 have a multilayer structure, the gap 224B is generated between each layer. The gap 224B causes lowering of the binding characteristics of the anode active material layer 22B as the gap 224A does. Therefore, to improve the binding characteristics, the metal material 226 fills in the gap 224B. In this case, though it is enough that part of the gap 224B is filled therewith, the larger filling amount is preferable, since thereby the binding characteristics of the anode active material layer 22B are further improved.

To prevent the fibrous minute projection (not illustrated) generated on the exposed face of the uppermost layer of the anode active material particles 221 from adversely affecting the performance of the secondary battery, the anode active material layer 22B may have the metal material 226 in the void 225. More specifically, in the case where the anode active material particles 221 are formed by vapor-phase deposition method or the like, the fibrous minute projections are generated on the surface thereof, and thus the void 225 is generated between the projections. The void 225 causes increase of the surface area of the anode active material particles 221, and accordingly the amount of an irreversible coat formed on the surface is also increased, possibly resulting in lowering of progression of charge and discharge reaction. Therefore, to inhibit the lowering of progression of the charge and discharge reaction, the foregoing void 225 is filled with the metal material 226. In this case, though it is enough at minimum that part of the void 225 is filled therewith, the larger filling amount is preferable, since thereby lowering of progression of the charge and discharge reaction is more inhibited. In FIGS. 6A and 6B, the metal material 226 is dotted on the surface of the uppermost layer of the anode active material particles 221, which means that the foregoing minute projection exists in the location where the metal material 226 is dotted. It is needless to say that the metal material 226 is not necessarily dotted on the surface of the anode active material particles 221, but may cover the entire surface thereof.

In particular, the metal material 226 that intrudes into the gap 224B has a function to fill in the void 225 in each layer. More specifically, in the case where the anode material is deposited several times, the foregoing minute projection is generated on the surface of the anode active material particles 221 for every deposition. Therefore, the metal material 226 fills in not only the gap 224B in each layer, but also the void 225 in each layer.

In FIGS. 5A to 6B, the description has been given of the case that the anode active material particles 221 have the multilayer structure, and both gaps 224A and 224B exist in the anode active material layer 22B. Thus, the anode active material layer 22B has the metal material 226 in the gaps 224A and 224B. Meanwhile, in the case where the anode active material particles 221 have a single layer structure, and only the gap 224A exists in the anode active material layer 22B, the anode active material layer 22B has the metal material 226 only in the gap 224A. It is needless to say that the void 225 is generated in both cases, and thus in any case, the metal material 226 is included in the void 225.

Separator

The separator 23 separates the cathode 21 from the anode 22, and passes lithium ions while preventing current short circuit resulting from contact of both electrodes. The separator 23 is impregnated with a liquid electrolyte (electrolytic solution). The separator 23 is made of, for example, a porous film composed of a synthetic resin such as polytetrafluoroethylene, polypropylene, and polyethylene, a ceramic porous film or the like. The separator 23 may be a laminated body composed of two or more porous films.

Electrolytic Solution

In the electrolytic solution, an electrolyte salt is dissolved in a nonaqueous solvent containing the foregoing cyclic polyester. The content of the cyclic polyester in the nonaqueous solvent is not particularly limited. However, specially, the content thereof is preferably from 0.01 wt % to 10 wt % both inclusive, since thereby while a high battery capacity is retained, superior cycle characteristics and superior storage characteristics are able to be obtained.

Nonaqueous Solvent

The nonaqueous solvent may contain other material as long as the nonaqueous solvent contains the cyclic polyester. Such other material means one or more of the organic solvents (nonaqueous solvents) described below and the like.

Examples of the nonaqueous solvents include the following compounds. That is, examples thereof include ethylene carbonate, propylene carbonate, butylene carbonate, dimethyl carbonate, diethyl carbonate, ethyl methyl carbonate, methylpropyl carbonate, γ-butyrolactone, γ-valerolactone, 1,2-dimethoxyethane, and tetrahydrofuran. Further examples thereof include 2-methyltetrahydrofuran, tetrahydropyran, 1,3-dioxolane, 4-methyl-1,3-dioxolane, 1,3-dioxane, and 1,4-dioxane. Furthermore, examples thereof include methyl acetate, ethyl acetate, methyl propionate, ethyl propionate, methyl butyrate, methyl isobutyrate, trimethyl methyl acetate, and trimethyl ethyl acetate. Furthermore, examples thereof include acetonitrile, glutaronitrile, adiponitrile, methoxyacetonitrile, 3-methoxypropionitrile, N,N-dimethylformamide, N-methylpyrrolidinone, and N-methyloxazolidinone. Furthermore, examples thereof include N,N′-dimethylimidazolidinone, nitromethane, nitroethane, sulfolane, trimethyl phosphate, and dimethyl sulfoxide. By using such a compound, superior battery capacity, superior cycle characteristics, superior storage characteristics and the like are obtained.

Specially, at least one of ethylene carbonate, propylene carbonate, dimethyl carbonate, diethyl carbonate, and ethyl methyl carbonate is preferable, since thereby superior battery capacity, superior cycle characteristics, superior storage characteristics and the like are obtained. In this case, a combination of a high viscosity (high dielectric constant) solvent (for example, specific inductive ε≧30) such as ethylene carbonate and propylene carbonate and a low viscosity solvent (for example, viscosity≦1 mPa·s) such as dimethyl carbonate, ethylmethyl carbonate, and diethyl carbonate is more preferable. Thereby, dissociation property of the electrolyte salt and ion mobility are improved.

In particular, the nonaqueous solvent preferably contains at least one of the unsaturated carbon bond cyclic ester carbonates expressed by Formula 2 to Formula 4. Thereby, a stable protective film is formed on the surface of the anode 22 or the like at the time of charge and discharge, and thus decomposition reaction of the electrolytic solution is inhibited. The “unsaturated carbon bond cyclic ester carbonate” is a cyclic ester carbonate having one or more unsaturated carbon bonds. The content of the unsaturated carbon bond cyclic ester carbonate in the nonaqueous solvent is, for example, from 0.01 wt % to 10 wt % both inclusive. The type of the unsaturated carbon bond cyclic ester carbonate is not limited to the after-mentioned examples, and may be other type.

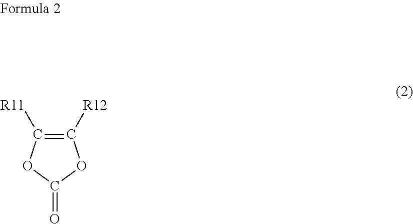

In the formula, R11 and R12 are a hydrogen group or an alkyl group.

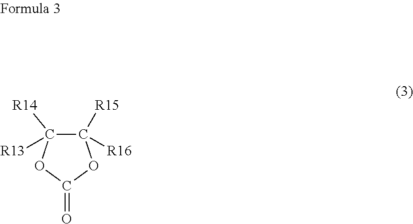

In the formula, R13 to R16 are a hydrogen group, an alkyl group, a vinyl group, or an aryl group. At least one of R13 to R16 is the vinyl group or the aryl group.

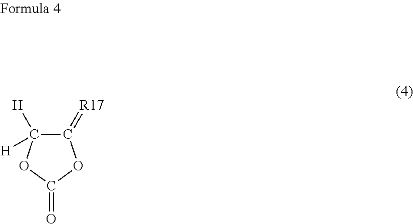

In the formula, R17 is an alkylene group.

The unsaturated carbon bond cyclic ester carbonate shown in Formula 2 is a vinylene carbonate compound. Examples of vinylene carbonate compounds include the following compounds. That is, examples thereof include vinylene carbonate, methylvinylene carbonate, and ethylvinylene carbonate. Further, examples thereof include 4,5-dimethyl-1,3-dioxole-2-one, 4,5-diethyl-1,3-dioxole-2-one, 4-fluoro-1,3-dioxole-2-one, and 4-trifluoromethyl-1,3-dioxole-2-one. Specially, vinylene carbonate is preferable, since vinylene carbonate is easily available and provides high effect.

The unsaturated carbon bond cyclic ester carbonate shown in Formula 3 is a vinylethylene carbonate compound. Examples of vinylethylene carbonate compounds include the following compounds. That is, examples thereof include vinylethylene carbonate, 4-methyl-4-vinyl-1,3-dioxolane-2-one, and 4-ethyl-4-vinyl-1,3-dioxolane-2-one. Further examples thereof include 4-n-propyl-4-vinyl-1,3-dioxolane-2-one, 5-methyl-4-vinyl-1,3-dioxolane-2-one, 4,4-divinyl-1,3-dioxolane-2-one, and 4,5-divinyl-1,3-dioxolane-2-one. Specially, vinylethylene carbonate is preferable, since vinylethylene carbonate is easily available, and provides high effect. It is needless to say that all of R13 to R16 may be the vinyl group or the aryl group. Otherwise, it is possible that some of R13 to R16 are the vinyl group, and the others thereof are the aryl group.

The unsaturated carbon bond cyclic ester carbonate shown in Formula 4 is a methylene ethylene carbonate compound. Examples of methylene ethylene carbonate compounds include the following compounds. That is, examples thereof include 4-methylene-1,3-dioxolane-2-one, 4,4-dimethyl-5-methylene-1,3-dioxolane-2-one, and 4,4-diethyl-5-methylene-1,3-dioxolane-2-one. The methylene ethylene carbonate compound may have one methylene group (compound shown in Formula 4), or have two methylene groups.

The unsaturated carbon bond cyclic ester carbonate may be catechol carbonate having a benzene ring or the like, in addition to the compounds shown in Formula 2 to Formula 4.

Further, the nonaqueous solvent preferably contains at least one of a halogenated chain ester carbonate shown in Formula 5 and a halogenated cyclic ester carbonate shown in Formula 6. Thereby, a stable protective film is formed on the surface of the anode 22 or the like at the time of charge and discharge, and thus decomposition reaction of the electrolytic solution is inhibited. “Halogenated chain ester carbonate” is a chain ester carbonate containing halogen as an element. “Halogenated cyclic ester carbonate” is a cyclic ester carbonate containing halogen as an element. R21 to R26 may be the same group, or may be a group different from each other. The same is applied to R27 to R30. The content of the halogenated chain ester carbonate and the halogenated cyclic ester carbonate in the nonaqueous solvent is, for example, from 0.01 wt % to 50 wt % both inclusive. The type of the halogenated chain ester carbonate or the halogenated cyclic ester carbonate is not necessarily limited to the compounds described below, and may be other compound.

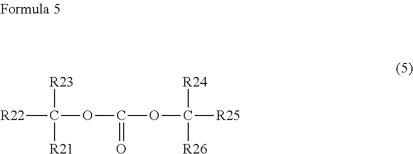

In the formula, R21 to R26 are a hydrogen group, a halogen group, an alkyl group, or a halogenated alkyl group. At least one of R21 to R26 is the halogen group or the halogenated alkyl group.

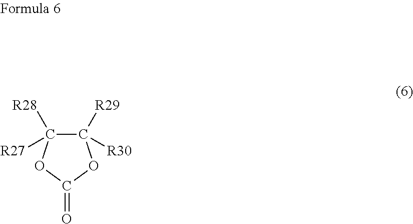

In the formula, R27 to R30 are a hydrogen group, a halogen group, an alkyl group, or a halogenated alkyl group. At least one of R27 to R30 is the halogen group or the halogenated alkyl group.

Though the halogen type is not particularly limited, specially, fluorine, chlorine, or bromine is preferable, and fluorine is more preferable, since thereby higher effect is obtained compared to other halogen. The number of halogen is more preferably two than one, and further may be three or more, since thereby an ability to form a protective film is improved, and a more rigid and stable protective film is formed. Accordingly, decomposition reaction of the electrolytic solution is more inhibited.

Examples of the halogenated chain ester carbonate include fluoromethyl methyl carbonate, bis(fluoromethyl)carbonate, and difluoromethyl methyl carbonate. Examples of the halogenated cyclic ester carbonate include the compounds expressed by Formula (6-1) to Formula (6-21). The halogenated cyclic ester carbonate include a geometric isomer. Specially, 4-fluoro-1,3-dioxolane-2-one shown in Formula (6-1) or 4,5-difluoro-1,3-dioxolane-2-one shown in Formula (6-3) is preferable, and the latter is more preferable. In particular, as 4,5-difluoro-1,3-dioxolane-2-one, a trans isomer is more preferable than a cis isomer, since the trans isomer is easily available and provides high effect.

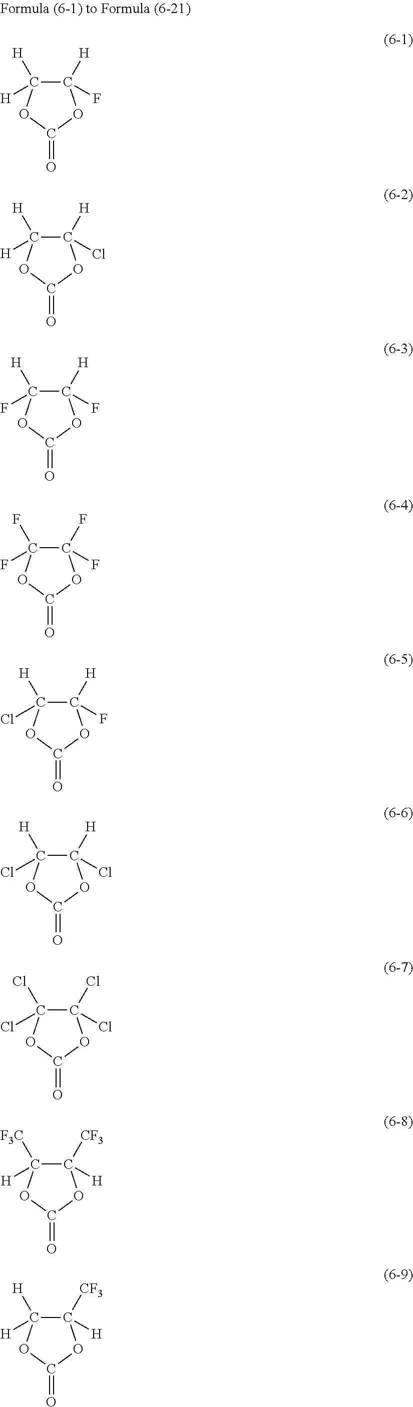

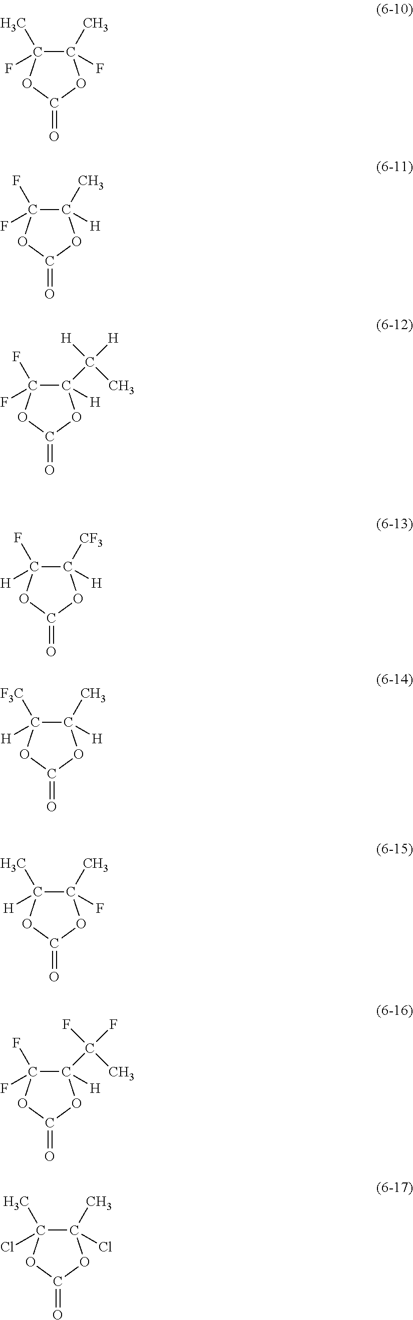

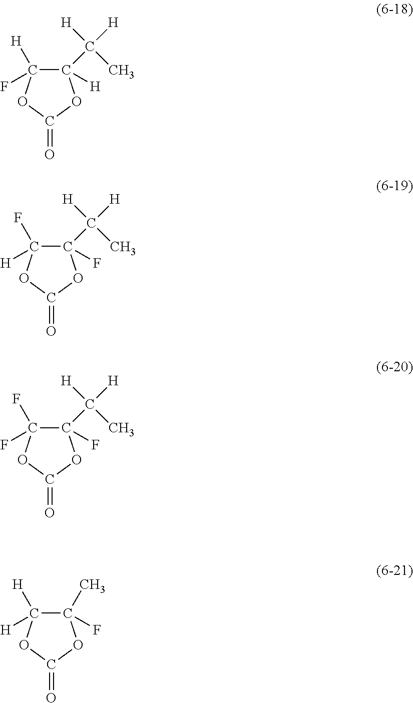

Further, the nonaqueous solvent preferably contains sultone (cyclic sulfonic ester), since thereby the chemical stability of the electrolytic solution is further improved. Examples of the sultone include propane sultone and propene sultone. The sultone content in the nonaqueous solvent is, for example, from 0.5 wt % to 5 wt % both inclusive. The type of sultone is not necessarily limited to the foregoing type.

Further, the nonaqueous solvent preferably contains an acid anhydride, since the chemical stability of the electrolytic solution is thereby further improved. Examples of the acid anhydrides include a carboxylic anhydride, a disulfonic anhydride, and an anhydride of carboxylic acid and sulfonic acid. Examples of the carboxylic anhydrides include succinic anhydride, glutaric anhydride, and maleic anhydride. Examples of disulfonic anhydrides include ethane disulfonic anhydride and propane disulfonic anhydride. Examples of the anhydride of carboxylic acid and sulfonic acid include sulfobenzoic anhydride, sulfopropionic anhydride, and sulfobutyric anhydride. The content of the acid anhydride in the nonaqueous solvent is, for example, from 0.5 wt % to 5 wt % both inclusive. However, the type of acid anhydride is not necessarily limited to the foregoing compound.

Electrolyte Salt

The electrolyte salt contains, for example, one or more light metal salts such as a lithium salt. The electrolyte salt may contain, for example, a salt other than a light metal salt.

Examples of lithium salts include the following compounds. That is, examples thereof include lithium hexafluorophosphate, lithium tetrafluoroborate, lithium perchlorate, and lithium hexafluoroarsenate. Further, examples thereof include lithium tetraphenylborate (LiB(C₆H₅)₄), lithium methanesulfonate (LiCH₃SO₃), lithium trifluoromethane sulfonate (LiCF₃SO₃), and lithium tetrachloroaluminate (LiAlCl₄). Further, examples thereof include dilithium hexafluorosilicate (Li₂SiF₆), lithium chloride (LiCl), and lithium bromide (LiBr). Further, examples thereof include dilithium monofluorophosphate (Li₂PFO₃) and lithium difluorophosphate (LiPF₂O₂). Thereby, superior battery capacity, superior cycle characteristics, superior storage characteristics and the like are obtained. The type of electrolyte salt is not necessarily limited to the foregoing compound, and may be other type of compound.

Specially, at least one of lithium hexafluorophosphate, lithium tetrafluoroborate, lithium perchlorate, and lithium hexafluoroarsenate is preferable, and lithium hexafluorophosphate is more preferable, since the internal resistance is lowered, and thus higher effect is obtained.

In particular, the electrolyte salt preferably contains at least one of the compounds expressed by Formula 7 to Formula 9, since thereby higher effect is obtained. R31 and R33 may be the same group, or may be a group different from each other. The same is applied to R41 to R43 and R51 and R52. The type of the electrolyte salt is not necessarily limited to the compounds described below, and may be other compound.

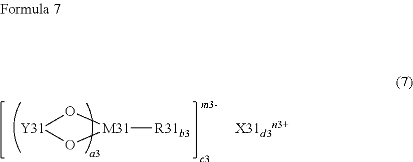

In the formula, X31 is a Group 1 element or a Group 2 element in the long period periodic table or aluminum. M31 is a transition metal element, a Group 13 element, a Group 14 element, or a Group 15 element in the long period periodic table. R31 is a halogen group. Y31 is —(O═)C—R32-C(═O)—, —(O═)C—C(R33)₂-, or —(O═)C—C(═O)—. R32 is an alkylene group, a halogenated alkylene group, an arylene group, or a halogenated arylene group. R33 is an alkyl group, a halogenated alkyl group, an aryl group, or a halogenated aryl group. a3 is one of integer numbers 1 to 4. b3 is 0, 2, or 4. c3, d3, m3, and n3 are one of integer numbers 1 to 3.

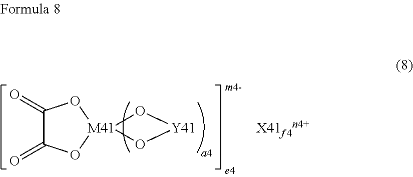

In the formula, X41 is a Group 1 element or a Group 2 element in the long period periodic table. M41 is a transition metal element, a Group 13 element, a Group 14 element, or a Group 15 element in the long period periodic table. Y41 is —(O═)C—(C(R41)₂)_{b4}-C(═O)—, —(R43)₂C—(C(R42)₂)_{c4}-C(═O)—, —(R43)₂C—(C(R42)₂)_{c4}-C(R43)₂-, —(R43)₂C—(C(R42)₂)_{c4}-S(═O)₂—, —(O═)₂S—(C(R42)₂)_{d4}-S(═O)₂—, or —(O═)C—(C(R42)₂)_{d4}-S(═O)₂—. R41 and R43 are a hydrogen group, an alkyl group, a halogen group, or a halogenated alkyl group. At least one of R41 and R43 is respectively the halogen group or the halogenated alkyl group. R42 is a hydrogen group, an alkyl group, a halogen group, or a halogenated alkyl group. a4, e4, and n4 are 1 or 2. b4 and d4 are one of integer numbers 1 to 4. c4 is one of integer numbers 0 to 4. f4 and m4 are one of integer numbers 1 to 3.

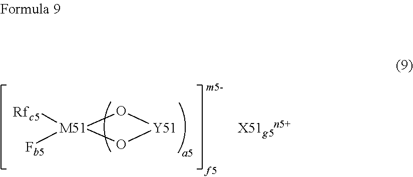

In the formula, X51 is a Group 1 element or a Group 2 element in the long period periodic table. M51 is a transition metal element, a Group 13 element, a Group 14 element, or a Group 15 element in the long period periodic table. Rf is a fluorinated alkyl group with the carbon number from 1 to 10 both inclusive or a fluorinated aryl group with the carbon number from 1 to 10 both inclusive. Y51 is —(O═)C—(C(R51)₂)_{d5}-C(═O)—, —(R52)₂C—(C(R51)₂)_{d5}-C(═O)—, —(R52)₂C—(C(R51)₂)_{d5}-C(R52)₂-, —(R52)₂C—(C(R51)₂)_{d5}-S(═O)₂—, —(O═)₂S—(C(R51)₂)_{c5}-S(═O)₂—, or —(O═)C—(C(R51)₂)ₑ₅-S(═O)₂—. R51 is a hydrogen group, an alkyl group, a halogen group, or a halogenated alkyl group. R52 is a hydrogen group, an alkyl group, a halogen group, or a halogenated alkyl group, and at least one thereof is the halogen group or the halogenated alkyl group. a5, f5, and n5 are 1 or 2. b5, c5, and e5 are one of integer numbers 1 to 4. d5 is one of integer numbers 0 to 4. g5 and m5 are one of integer numbers 1 to 3.

Group 1 element represents hydrogen, lithium, sodium, potassium, rubidium, cesium, and francium. Group 2 element represents beryllium, magnesium, calcium, strontium, barium, and radium. Group 13 element represents boron, aluminum, gallium, indium, and thallium. Group 14 element represents carbon, silicon, germanium, tin, and lead. Group 15 element represents nitrogen, phosphorus, arsenic, antimony, and bismuth.

Examples of the compound shown in Formula 7 include the compounds expressed by Formula (7-1) to Formula (7-6). Examples of the compound shown in Formula 8 include the compounds expressed by Formula (8-1) to Formula (8-8). Examples of the compound shown in Formula 9 include the compound shown in Formula (9-1).

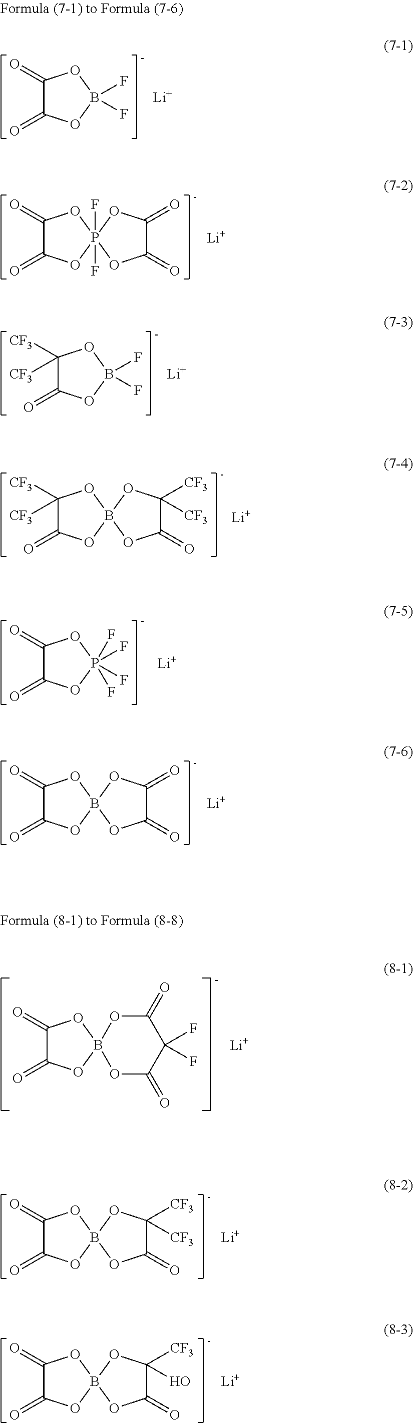

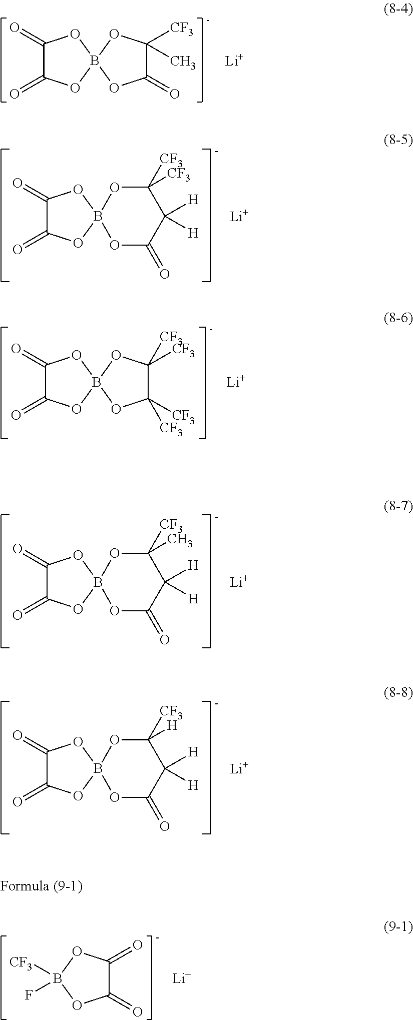

Further, the electrolyte salt preferably contains at least one of the compounds expressed by Formula 10 to Formula 12, since thereby higher effect is obtained. m and n may be the same value or a value different from each other. The same is applied to p, q, and r. The type of the electrolyte salt is not necessarily limited to the compounds described below, and may be other compound.

Formula 10

LiN(CₘF₂ₘ₊1SO2)(CₙF₂ₙ₊₁SO₂) (10)

In the formula, m and n are an integer number greater than 1 or equal to 1.

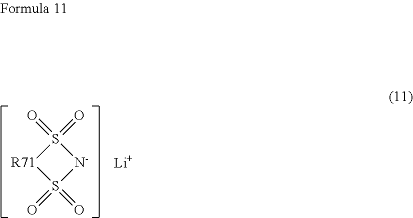

In the formula, R71 is a straight chain or branched perfluoro alkylene group with the carbon number from 2 to 4 both inclusive.

Formula 12

LiC(CₚF₂ₚ₊₁SO₂)(C_{q}F_{2q+1}SO₂)(CᵣF₂ᵣ₊₁SO₂) (12)

In the formula, p, q, and r are an integer number greater than 1 or equal to 1.

The compound shown in Formula 10 is a chain imide compound. Examples of the compounds include the following compounds. That is, examples thereof include lithium bis(trifluoromethanesulfonyl)imide (LiN(CF₃SO₂)₂) and lithium bis(pentafluoroethanesulfonyl)imide (LiN(C₂F₅SO₂)₂). Further examples thereof include lithium (trifluoromethanesulfonyl)(pentafluoroethanesulfonyl)imide (LiN(CF₃SO₂)(C₂F₅SO₂)). Further examples thereof include lithium (trifluoromethanesulfonyl)(heptafluoropropanesulfonyl)imide (LiN(CF₃SO₂)(C₃F₇SO₂)). Further examples thereof include lithium (trifluoromethanesulfonyl)(nonafluorobutanesulfonyl)imide (LiN(CF₃SO₂)(C₄F₉SO₂)).

Examples of the compound shown in Formula 11 include a cyclic imide compound. Examples of the compounds include the compounds expressed by Formula (11-1) to Formula (11-4).

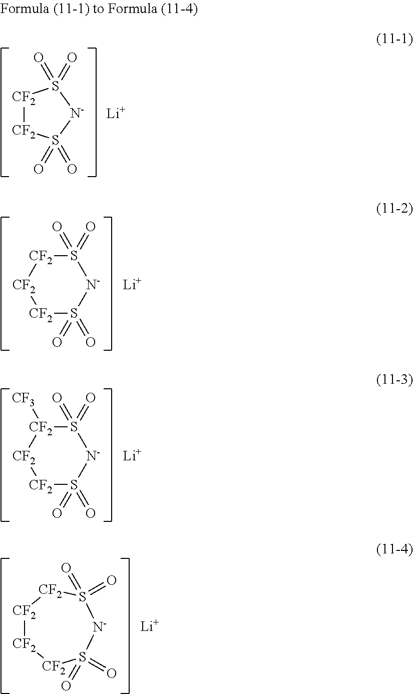

The compound shown in Formula 12 is a chain methyde compound. Examples of the compound include lithium tris(trifluoromethanesulfonyl)methyde (LiC(CF₃SO₂)₃).

The content of the electrolyte salt with respect to the nonaqueous solvent is preferably from 0.3 mol/kg to 3.0 mol/kg both inclusive, since thereby high ion conductivity is obtained.

Operation of Secondary Battery

In the secondary battery, at the time of charge, for example, lithium ions are extracted from the cathode 21, and are inserted in the anode 22 through the electrolytic solution impregnating in the separator 23. Meanwhile, at the time of discharge, for example, lithium ions are extracted from the anode 22, and are inserted in the cathode 21 through the electrolytic solution impregnating in the separator 23.

Method of Manufacturing Secondary Battery

The secondary battery is manufactured, for example, by the following procedure.

First, the cathode 21 is formed. First, a cathode active material is mixed with a cathode binder, a cathode electrical conductor or the like according to needs to prepare a cathode mixture, which is subsequently dispersed in an organic solvent to obtain paste cathode mixture slurry. Subsequently, both faces of the cathode current collector 21A are uniformly coated with the cathode mixture slurry, which is dried to form the cathode active material layer 21B. Finally, the cathode active material layer 21B is compression-molded by using a rolling press machine or the like while being heated if necessary. In this case, the resultant may be compression-molded over several times.

Next, the anode 22 is formed by a procedure similar to that of the foregoing cathode 21. In this case, an anode active material is mixed with an anode binder, an anode electrical conductor or the like according to needs to prepare an anode mixture, which is subsequently dispersed in an organic solvent to form paste anode mixture slurry. After that, both faces of the anode current collector 22A are uniformly coated with the anode mixture slurry to form the anode active material layer 22B. After that, the anode active material layer 22B is compression-molded.

The anode 22 may be formed by a procedure different from that of the cathode 21. In this case, first, the anode material is deposited on both faces of the anode current collector 22A by using vapor-phase deposition method such as evaporation method to form a plurality of anode active material particles. After that, according to needs, an oxide-containing film is formed by using liquid-phase deposition method such as liquid-phase precipitation method, or a metal material is formed by using liquid-phase deposition method such as electrolytic plating method, or both the oxide-containing film and the metal material are formed to form the anode active material layer 22B.

Next, cyclic polyester is dissolved or dispersed in a nonaqueous solvent. After that, an electrolyte salt is dissolved in the nonaqueous solvent containing the cyclic polyester, and thereby an electrolytic solution is prepared.

Finally, the secondary battery is assembled by using the electrolytic solution together with the cathode 21 and the anode 22. First, the cathode lead 25 is attached to the cathode current collector 21A by welding or the like, and the anode lead 26 is attached to the anode current collector 22A by welding or the like. Subsequently, the cathode 21 and the anode 22 are layered with the separator 23 in between and spirally wound, and thereby the spirally wound electrode body 20 is formed. After that, the center pin 24 is inserted in the center of the spirally wound electrode body 20. Subsequently, the spirally wound electrode body 20 is sandwiched between the pair of insulating plates 12 and 13, and contained in the battery can 11. In this case, the end of the cathode lead 25 is attached to the safety valve mechanism 15 by welding or the like, and the end of the anode lead 26 is attached to the battery can 11 by welding or the like. Subsequently, the electrolytic solution is injected into the battery can 11 and the separator 23 is impregnated with the electrolytic solution. Finally, at the open end of the battery can 11, the battery cover 14, the safety valve mechanism 15, and the PTC device 16 are fixed by being caulked with the gasket 17. The secondary battery illustrated in FIG. 1 and FIG. 2 is thereby completed.

According to the lithium ion secondary battery, the nonaqueous solvent of the electrolytic solution contains the foregoing cyclic polyester. Thus, since decomposition reaction of the electrolytic solution at the time of charge and discharge is inhibited, the cycle characteristics and the storage characteristics are able to be improved. In this case, in the case where the content of the cyclic polyester in the electrolytic solution is from 0.01 wt % to 10 wt % both inclusive in the nonaqueous solvent, higher effect is able to be obtained.

Further, in the case where the nonaqueous solvent of the electrolytic solution contains at least one of unsaturated carbon bond cyclic ester carbonate, halogenated chain ester carbonate, halogenated cyclic ester carbonate, sultone, and acid anhydride, higher effect is able to be obtained. Further, in the case where the electrolyte salt contains at least one of lithium hexafluorophosphate, lithium tetrafluoroborate, lithium perchlorate, lithium hexafluoroarsenate, and the compounds shown in Formula 7 to Formula 12, higher effect is able to be obtained.

Further, in the case where the metal material advantageous to realizing a high capacity as an anode active material of the anode 22 (simple substance of silicon, the SnCoC-containing material or the like) is used, the cycle characteristics and the like are improved. Thus, higher effect is able to be obtained than in a case that other anode material such as a carbon material is used.

2-2. Lithium Ion Secondary Battery (Laminated Film Type)

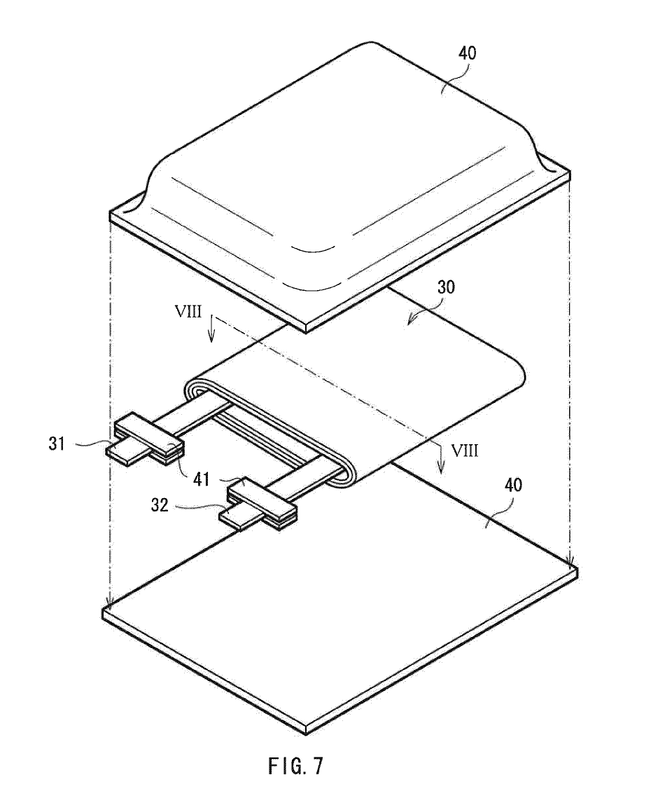

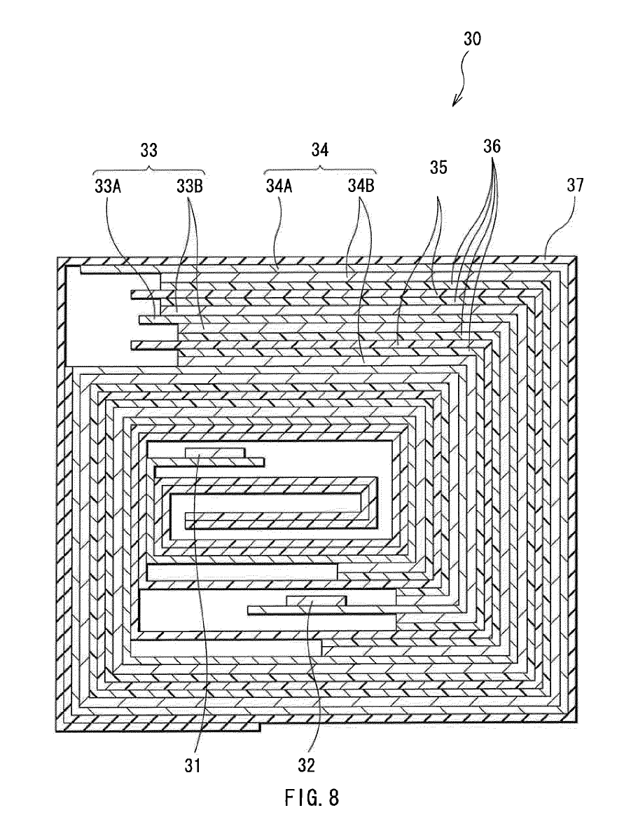

FIG. 7 illustrates an exploded perspective structure of a lithium ion secondary battery (laminated film type). FIG. 8 illustrates an exploded cross section taken along line VIII-VIII of a spirally wound electrode body 30 illustrated in FIG. 7.

In the secondary battery, the spirally wound electrode body 30 is contained in a film package member 40 mainly. The spirally wound electrode body 30 is a spirally wound laminated body in which a cathode 33 and an anode 34 are layered with a separator 35 and an electrolyte layer 36 in between and are spirally wound. A cathode lead 31 is attached to the cathode 33, and an anode lead 32 is attached to the anode 34. The outermost peripheral section of the spirally wound electrode body 30 is protected by a protective tape 37.

The cathode lead 31 and the anode lead 32 are, for example, respectively derived from inside to outside of the package member 40 in the same direction. The cathode lead 31 is made of, for example, a conductive material such as aluminum, and the anode lead 32 is made of, for example, a conducive material such as copper, nickel, and stainless steel. These materials are in the shape of, for example, a thin plate or mesh.

The package member 40 is a laminated film in which, for example, a fusion bonding layer, a metal layer, and a surface protective layer are layered in this order. In this case, for example, the respective outer edges of the fusion bonding layer of two films are bonded to each other by fusion bonding, an adhesive or the like so that the fusion bonding layer and the spirally wound electrode body 30 are opposed to each other. Examples of fusion bonding layers include a polymer film made of polyethylene, polypropylene or the like. Examples of metal layers include a metal foil such as an aluminum foil. Examples of surface protective layers include a polymer film made of nylon, polyethylene terephthalate or the like.

Specially, as the package member 40, an aluminum laminated film in which a polyethylene film, an aluminum foil, and a nylon film are layered in this order is preferable. However, the package member 40 may be made of a laminated film having other laminated structure, a polymer film such as polypropylene, or a metal film instead of the foregoing aluminum laminated film.

An adhesive film 41 to protect from entering of outside air is inserted between the package member 40 and the cathode lead 31, the anode lead 32. The adhesive film 41 is made of a material having contact characteristics with respect to the cathode lead 31 and the anode lead 32. Examples of such a material include a polyolefin resin such as polyethylene, polypropylene, modified polyethylene, and modified polypropylene.

In the cathode 33, a cathode active material layer 33B is provided on both faces of a cathode current collector 33A. The structures of the cathode current collector 33A and the cathode active material layer 33B are respectively similar to the structures of the cathode current collector 21A and the cathode active material layer 21B. In the anode 34, for example, an anode active material layer 34B is provided on both faces of an anode current collector 34A. The structure of the anode current collector 34A and the anode active material layer 34B are respectively similar to the structures of the anode current collector 22A and the anode active material layer 22B.

The structure of the separator 35 is similar to the structure of the separator 23.

In the electrolyte layer 36, an electrolytic solution is held by a polymer compound. The electrolyte layer 36 may contain other material such as various additives according to needs. The electrolyte layer 36 is a so-called gel electrolyte. The gel electrolyte is preferable, since thereby high ion conductivity (for example, 1 mS/cm or more at room temperature) is obtained and liquid leakage of the electrolytic solution is prevented.

Examples of polymer compounds include at least one of the following polymer materials. That is, examples thereof include polyacrylonitrile, polyvinylidene fluoride, polytetrafluoroethylene, polyhexafluoropropylene, polyethylene oxide, polypropylene oxide, polyphosphazene, polysiloxane, and polyvinyl fluoride. Further, examples thereof include polyvinyl acetate, polyvinyl alcohol, polymethacrylic acid methyl, polyacrylic acid, polymethacrylic acid, styrene-butadiene rubber, nitrile-butadiene rubber, polystyrene, and polycarbonate. Further examples thereof include a copolymer of vinylidene fluoride and hexafluoropropylene. Such polymer compounds may be used singly, or a plurality thereof may be used by mixture. Specially, polyvinylidene fluoride or the copolymer of vinylidene fluoride and hexafluoropropylene is preferable, since such a polymer compound is electrochemically stable.

The composition of the electrolytic solution is similar to the composition of the electrolytic solution in the cylindrical type secondary battery. However, in the electrolyte layer 36 as the gel electrolyte, a nonaqueous solvent of the electrolytic solution means a wide concept including not only the liquid solvent but also a material having ion conductivity capable of dissociating the electrolyte salt. Therefore, in the case where the polymer compound having ion conductivity is used, the polymer compound is also contained in the nonaqueous solvent.

Instead of the gel electrolyte layer 36 in which the electrolytic solution is held by the polymer compound, the electrolytic solution may be directly used. In this case, the separator 35 is impregnated with the electrolytic solution.

In the secondary battery, at the time of charge, for example, lithium ions are extracted from the cathode 33, and are inserted in the anode 34 through the electrolyte layer 36. Meanwhile, at the time of discharge, for example, lithium ions are extracted from the anode 34, and are inserted in the cathode 33 through the electrolyte layer 36.

The secondary battery including the gel electrolyte layer 36 is manufactured, for example, by the following three procedures.

In the first procedure, first, the cathode 33 and the anode 34 are formed by a procedure similar to that of the cathode 21 and the anode 22. Specifically, the cathode 33 is formed by forming the cathode active material layer 33B on both faces of the cathode current collector 33A, and the anode 34 is formed by forming the anode active material layer 34B on both faces of the anode current collector 34A. Subsequently, a precursor solution containing an electrolytic solution, a polymer compound, and a solvent is prepared. The cathode 33 and the anode 34 are coated with the precursor solution. After that, the solvent is volatilized to form the gel electrolyte layer 36. Subsequently, the cathode lead 31 is attached to the cathode current collector 33A by welding or the like, and the anode lead 32 is attached to the anode current collector 34A by welding or the like. Subsequently, the cathode 33 and the anode 34 provided with the electrolyte layer 36 are layered with the separator 35 in between and spirally wound. After that, the protective tape 37 is adhered to the outermost periphery thereof to form the spirally wound electrode body 30. Finally, after the spirally wound electrode body 30 is sandwiched between two pieces of film-like package members 40, outer edges of the package members 40 are contacted by thermal fusion bonding or the like to enclose the spirally wound electrode body 30 into the package members 40. At this time, the adhesive films 41 are inserted between the cathode lead 31, the anode lead 32 and the package member 40.

In the second procedure, first, the cathode lead 31 is attached to the cathode 33, and the anode lead 32 is attached to the anode 34. Subsequently, the cathode 33 and the anode 34 are layered with the separator 35 in between and spirally wound. After that, the protective tape 37 is adhered to the outermost periphery thereof to form a spirally wound body as a precursor of the spirally wound electrode body 30. Subsequently, after the spirally wound body is sandwiched between two pieces of the film-like package members 40, the outermost peripheries except for one side are bonded by thermal fusion bonding or the like, and the spirally wound body is contained in the pouch-like package member 40. Subsequently, a composition of matter for electrolyte containing an electrolytic solution, a monomer as a raw material for the polymer compound, a polymerization initiator, and if necessary other material such as a polymerization inhibitor is prepared, which is injected into the pouch-like package member 40. After that, the opening of the package member 40 is hermetically sealed by thermal fusion bonding or the like. Finally, the monomer is thermally polymerized to obtain a polymer compound. Thereby, the gel electrolyte layer 36 is formed.

In the third procedure, the spirally wound body is formed and contained in the pouch-like package member 40 in the same manner as that of the foregoing second procedure, except that the separator 35 with both faces coated with a polymer compound is used firstly. Examples of polymer compounds with which the separator 35 is coated include a polymer containing vinylidene fluoride as a component (a homopolymer, a copolymer, a multicomponent copolymer or the like). Specific examples thereof include polyvinylidene fluoride, a binary copolymer containing vinylidene fluoride and hexafluoropropylene as a component, and a ternary copolymer containing vinylidene fluoride, hexafluoropropylene, and chlorotrifluoroethylene as a component. In addition to the foregoing polymer containing vinylidene fluoride as a component, another one or more polymer compounds may be contained in the polymer compound. Subsequently, an electrolytic solution is prepared and injected into the package member 40. After that, the opening of the package member 40 is sealed by thermal fusion bonding or the like. Finally, the resultant is heated while a weight is applied to the package member 40, and the separator 35 is contacted with the cathode 33 and the anode 34 with the polymer compound in between. Thereby, the polymer compound is impregnated with the electrolytic solution, and accordingly the polymer compound is gelated to form the electrolyte layer 36.

In the third procedure, battery swollenness is inhibited compared to the first procedure. Further, in the third procedure, the monomer, other materials and the like as a raw material of the polymer compound are hardly left in the electrolyte layer 36 compared to in the second procedure. In addition, the formation step of the polymer compound is favorably controlled. Therefore, sufficient contact characteristics are obtained between the cathode 33/the anode 34/the separator 35 and the electrolyte layer 36.

According to the lithium ion secondary battery, the electrolytic solution of the electrolyte layer 36 contains the foregoing cyclic polyester. Therefore, the cycle characteristics and the storage characteristics are able to be improved by action similar to that of the cylindrical type secondary battery. Other effects of the lithium ion secondary battery are similar to those of the cylindrical type secondary battery.

2-3. Lithium Metal Secondary Battery

A secondary battery herein described is a lithium metal secondary battery in which the anode capacity is expressed by precipitation and dissolution of lithium metal. The secondary battery has a structure similar to that of the foregoing lithium ion secondary battery (cylindrical type), except that the anode active material layer 22B is formed from lithium metal, and is manufactured by a procedure similar to that of the foregoing lithium ion secondary battery (cylindrical type).

In the secondary battery, lithium metal is used as an anode active material, and thereby a higher energy density is able to be obtained. It is possible that the anode active material layer 22B already exists at the time of assembling, or the anode active material layer 22B does not exist at the time of assembling and is to be composed of lithium metal to be precipitated at the time of charge. Further, it is possible that the anode active material layer 22B is used as a current collector as well, and the anode current collector 22A is omitted.

In the secondary battery, at the time of charge, for example, lithium ions are extracted from the cathode 21, and are precipitated as lithium metal on the surface of the anode current collector 22A through the electrolytic solution impregnating in the separator 23. Meanwhile, at the time of discharge, for example, lithium metal is eluted as lithium ions from the anode active material layer 22B, and is inserted in the cathode 21 through the electrolytic solution impregnating in the separator 23.

According to the lithium metal secondary battery, the electrolytic solution contains the foregoing cyclic polyester. Therefore, the cycle characteristics and the storage characteristics are able to be improved by action similar to that of the lithium ion secondary battery. Other effects of the lithium metal secondary battery are similar to those of the lithium ion secondary battery. The foregoing lithium metal secondary battery is not limited to the cylindrical type secondary battery, but may be a laminated film type secondary battery. In this case, similar effect is able to be also obtained.

3. Application of the Lithium Secondary Battery

Next, a description will be given of an application example of the foregoing secondary battery.

Applications of the secondary battery are not particularly limited as long as the secondary battery is applied to a machine, a device, an instrument, an equipment, a system (collective entity of a plurality of devices and the like) or the like that is able to use the secondary battery as a driving electric power source, an electric power storage source for electric power storage or the like. In the case where the secondary battery is used as an electric power source, the secondary battery may be used as a main electric power source (electric power source used preferentially), or an auxiliary electric power source (electric power source used instead of a main electric power source or used being switched from the main electric power source). In the latter case, the main electric power source type is not limited to the secondary battery.

Examples of applications of the secondary battery include portable electronic devices such as a video camera, a digital still camera, a mobile phone, a notebook personal computer, a cordless phone, a headphone stereo, a portable radio, a portable television, and a Personal Digital Assistant (PDA); a portable lifestyle device such as an electric shaver; a storage equipment such as a backup electric power source and a memory card; an electric power tool such as an electric drill and an electric saw; a medical electronic device such as a pacemaker and a hearing aid; a vehicle such as an electrical vehicle (including a hybrid vehicle); and an electric power storage system such as a home battery system for storing electric power for emergency or the like.

Specially, the secondary battery is effectively applied to the electric power tool, the electrical vehicle, the electric power storage system or the like. In these applications, since superior characteristics (cycle characteristics, storage characteristics and the like) of the secondary battery are demanded, the characteristics are able to be effectively improved by using the secondary battery of the application. The electric power tool is a tool in which a moving part (for example, a drill or the like) is moved by using the secondary battery as a driving electric power source. The electrical vehicle is a vehicle that acts (runs) by using the secondary battery as a driving electric power source. As described above, a vehicle including a driving source as well other than the secondary battery (hybrid vehicle or the like) may be adopted. The electric power storage system is a system using the secondary battery as an electric power storage source. For example, in a home electric power storage system, electric power is stored in the secondary battery as an electric power storage source, and the electric power stored in the secondary battery is consumed according to needs. In result, various devices such as home electric products become usable.

### EXAMPLES

Specific examples of the application will be described in detail.

### Examples 1-1 to 1-13

The cylindrical type lithium ion secondary batteries illustrated in FIG. 1 and FIG. 2 were fabricated by the following procedure.

First, the cathode 21 was formed. First, lithium carbonate (Li₂CO₃) and cobalt carbonate (CoCO₃) were mixed at a molar ratio of 0.5:1. After that, the mixture was fired in the air at 900 deg C. for 5 hours. Thereby, lithium-cobalt composite oxide (LiCoO₂) was obtained. Subsequently, 91 parts by mass of lithium-cobalt composite oxide as a cathode active material, 6 parts by mass of graphite as a cathode electrical conductor, and 3 parts by mass of polyvinylidene fluoride as a cathode binder were mixed to obtain a cathode mixture. Subsequently, the cathode mixture was dispersed in N-methyl-2-pyrrolidone to obtain paste cathode mixture slurry. Subsequently, both faces of the cathode current collector 21A were uniformly coated with the cathode mixture slurry by using a coating device, which was dried to form the cathode active material layer 21B. As the cathode current collector 21A, a strip-shaped aluminum foil (thickness: 20 μm) was used. Finally, the cathode active material layer 21B was compression-molded by using a roll pressing machine.

Next, the anode 22 was formed. First, 90 parts by mass of artificial graphite as an anode active material and 10 parts by mass of polyvinylidene fluoride as an anode binder were mixed to obtain an anode mixture. Subsequently, the anode mixture was dispersed in N-methyl-2-pyrrolidone to obtain paste anode mixture slurry. Subsequently, both faces of the anode current collector 22A were uniformly coated with the anode mixture slurry by using a coating device, which was dried to form the anode active material layer 22B. As the anode current collector 22A, a strip-shaped electrolytic copper foil (thickness: 15 μm) was used. Finally, the anode active material layer 22B was compression-molded by using a roll pressing machine.

Next, an electrolyte salt was dissolved in a nonaqueous solvent, and an electrolytic solution was prepared so that the compositions illustrated in Table 1 were obtained. In this case, ethylene carbonate (EC) and dimethyl carbonate (DMC) were mixed at a weight ratio of EC and DMC was 50:50. After that, other nonaqueous solvent such as cyclic polyester was added as illustrated in Table 1 to prepare a nonaqueous solvent. After that, lithium hexafluorophosphate (LiPF₆) was dissolved in the nonaqueous solvent as an electrolyte salt. In this case, the content of the electrolyte salt was 1 mol/kg with respect to the nonaqueous solvent.

Finally, the secondary battery was assembled by using the cathode 21, the anode 22, and the electrolytic solution. First, the cathode lead 25 made of aluminum was welded to one end of the cathode current collector 21A, and the anode lead 26 made of nickel was welded to one of the anode current collector 22A. Subsequently, the cathode 21 and the anode 22 were layered with the separator 23 in between and spirally wound to form the spirally wound electrode body 20. After that, the center pin 24 was inserted in the center of the spirally wound electrode body. As the separator 23, a three layer structure (thickness: 23 μm) in which a film made of microporous polyethylene as a main component was sandwiched between films made of microporous polypropylene as a main component was used. Subsequently, while the spirally wound electrode body 20 was sandwiched between the pair of insulating plates 12 and 13, the spirally wound electrode body 20 was contained in the battery can 11. In this case, one end of the cathode lead 25 was welded to the safety valve mechanism 15, and one end of the anode lead 26 was welded to the battery can 11. Subsequently, the electrolytic solution was injected into the battery can 11, and the separator 23 was impregnated with the electrolytic solution. Finally, at the open end of the battery can 11, the battery cover 14, the safety valve mechanism 15, and the PTC device 16 were fixed by being caulked with the gasket 17. The cylindrical type secondary battery was thereby completed. In forming the secondary battery, lithium metal was prevented from being precipitated on the anode 22 at the full charged state by adjusting the thickness of the cathode active material layer 21B.

The cycle characteristics and the storage characteristics for the secondary battery were examined. The results illustrated in Table 1 were obtained.

In examining the cycle characteristics, first, two cycles of charge and discharge were performed in the atmosphere at 23 deg C., and the discharge capacity at the second cycle was measured. Subsequently, the secondary battery was charged and discharged repeatedly in the same atmosphere until the total number of cycles became 300 cycles, and the discharge capacity at the 300th cycle was measured. Finally, the cycle retention ratio (%)=(discharge capacity at the 300th cycle/discharge capacity at the second cycle)*100 was calculated. At the time of charge, constant current and constant voltage charge was performed at a current of 0.2 C until the upper voltage of 4.2 V. At the time of discharge, constant current discharge was performed at a current of 0.2 C until the final voltage of 2.7 V. “0.2 C” is a current value at which the theoretical capacity is discharged up in 5 hours.

In examining the storage characteristics, first, 2 cycles of charge and discharge were performed in the atmosphere at 23 deg C., and the discharge capacity before storage was measured. Subsequently, after the battery was stored for 10 days in a constant temperature bath at 80 deg C. in a state of being charged again, discharge was performed in the atmosphere at 23 deg C., and the discharge capacity after storage was measured. Finally, the high temperature storage retention ratio (%)=(discharge capacity after storage/discharge capacity before storage)*100 was calculated. The charge and discharge conditions were similar to those in the case of examining the cycle characteristics.

TABLE 1
Anode active material: artificial graphite

| | | Other | | | | Storage |
|---|---|---|---|---|---|---|
| | | electrolyte salt | | | | retention |
| | Nonaqueous | | Content | Electrolyte | Cycle retention | ratio |
| Table 1 | solvent | Type | (wt %) | salt | ratio (%) | (%) |
| Example 1-1 | EC + DMC | (1-4) | 0.01 | LiPF₆ | 83 | 87 |
| Example 1-2 | | | 0.5 | | 86 | 88 |
| Example 1-3 | | | 1 | | 89 | 91 |
| Example 1-4 | | | 2 | | 88 | 92 |
| Example 1-5 | | | 5 | | 87 | 92 |
| Example 1-6 | | | 10 | | 86 | 91 |
| Example 1-7 | | (1-20) | 0.5 | | 84 | 86 |
| Example 1-8 | | | 1 | | 87 | 90 |
| Example 1-9 | | | 2 | | 86 | 90 |
| Example 1-10 | | | 5 | | 86 | 88 |
| Example 1-11 | EC + DMC | — | — | LiPF₆ | 82 | 84 |
| Example 1-12 | | 13 | 1 | | 80 | 84 |
| Example 1-13 | | 14 | 1 | | 82 | 85 |

In the case where the cyclic polyester was used, the cycle retention ratio and the storage retention ratio were improved more than in the case not using the cyclic polyester. The result showed that by using the cyclic polyester, decomposition inhibition effect of the electrolytic solution at the time of charge and discharge was significantly demonstrated, and thermal stability was improved.

In this case, in particular, in the case where the content of the cyclic polyester was from 0.01 wt % to 10 wt % both inclusive, more favorable result was obtained.

### Examples 2-1 to 2-14

Secondary batteries were fabricated by a procedure similar to that of Examples 1-3, 1-4, and 1-11 except that the composition of the nonaqueous solvent was changed as illustrated in Table 2, and the respective characteristics were examined. In this case, as a nonaqueous solvent, diethyl carbonate (DEC), ethylmethyl carbonate (EMC), or propylene carbonate (PC) was used. Further, vinylene carbonate (VC), bis(fluoromethyl)carbonate (DFDMC), 4-fluoro-1,3-dioxolane-2-one (FEC), or trans-4,5-difluoro-1,3-dioxolane-2-one (DFEC) was used. Further, propene sultone (PRS), sulfobenzoic anhydride (SBAH), or sulfopropionic anhydride (SPAH) was used. In this case, the mixture ratio of EC, DEC and the like was EC:DEC=50:50, EC:EMC=50:50, PC:DMC=50:50, and EC:PC:DMC=10:20:70 at a weight ratio. The content of VC, DFDMC, FEC, and DFEC in the nonaqueous solvent was 2 wt %, and the content of PRS, SBAH, and SPAH was 1 wt %.

TABLE 2
Anode active material: artificial graphite

| | | | Other nonaqueous | | | | |
|---|---|---|---|---|---|---|---|
| | | | solvent | | | Cycle retention | Storage |
| | | | | Content | | ratio | retention ratio |
| Table 2 | Nonaqueous solvent | | Type | (wt %) | Electrolyte salt | (%) | (%) |
| Example 2-1 | EC + DEC | | (1-4) | 1 | LiPF₆ | 85 | 92 |
| Example 2-2 | EC + EMC | | | | | 88 | 92 |
| Example 2-3 | PC + DMC | | | | | 84 | 93 |
| Example 2-4 | EC + PC + DMC | | | | | 88 | 93 |
| Example 2-5 | EC + DMC | VC | | 2 | | 92 | 96 |
| Example 2-6 | | DFDMC | | | | 94 | 93 |
| Example 2-7 | | FEC | | | | 94 | 95 |
| Example 2-8 | | DFEC | | | | 92 | 94 |
| Example 2-9 | | PRS | | 1 | | 89 | 96 |
| Example 2-10 | | SBAH | | | | 89 | 97 |
| Example 2-11 | | SPAH | | | | 90 | 97 |
| Example 2-12 | EC + DMC | VC | — | — | LiPF₆ | 84 | 88 |
| Example 2-13 | | FEC | | | | 87 | 92 |
| Example 2-14 | | DFEC | | | | 85 | 92 |

In the case where the composition of the nonaqueous solvent was changed, high cycle retention ratio and high storage retention ratio were obtained as the result of Table 1.

### Examples 3-1 to 3-4

Secondary batteries were fabricated by a procedure similar to that of Example 1-3 except that the composition of the electrolyte salt was changed as illustrated in Table 3, and the respective characteristics were examined. In this case, as an electrolyte salt, lithium tetrafluoroborate (LiBF₄), lithium difluorophosphate (LiPF₂O₂), (4,4,4-trifluorobutyrate oxalato) lithium borate (LiTFOB) shown in Formula (8-8), or lithium bis(trifluoromethanesulfonyl)imide (LiN(CF₃SO₂)₂: LiTFSI) was used. Further, in Examples 3-1, 3-3, and 3-4, the content of LiPF₆ with respect to the nonaqueous solvent was 0.9 mol/kg, and the content of LiBF₄ or the like with respect to the nonaqueous solvent was 0.1 mol/kg. In Example 3-2, the content of LiPF₆ with respect to the nonaqueous solvent was 1 mol/kg, and the content of LiPF₂O₂ with respect to the nonaqueous solvent was 0.01 wt %.

TABLE 3
Anode active material: artificial graphite

| | | Other nonaqueous | | | | | |
|---|---|---|---|---|---|---|---|
| | | solvent | | | | Cycle retention | Storage |
| | Nonaqueous | | Content | | | ratio | retention ratio |
| Table 3 | solvent | Type | (wt %) | Electrolyte salt | | (%) | (%) |
| Example 3-1 | EC + DMC | (1-4) | 1 | LiPF₆ | LiBF₄ | 89 | 94 |
| Example 3-2 | | | | | LiPF₂O₂ | 89 | 94 |
| Example 3-3 | | | | | LiTFOB | 90 | 94 |
| Example 3-4 | | | | | LiTFSI | 89 | 94 |

In the case where the composition of the electrolyte salt was changed, high cycle retention ratio and high storage retention ratio were obtained as in the result of Table 1.

### Examples 4-1 to 4-11

Secondary batteries were fabricated by a procedure similar to that of Examples 1-1 to 1-13 except that silicon was used as an anode active material, and DEC was used instead of DMC as illustrated in Table 4, and the respective characteristics were examined. In forming the anode 22, silicon was deposited on the surface of the anode current collector 22A by evaporation method (electron beam evaporation method) to form the anode active material layer 22B containing a plurality of anode active material particles. In this case, 10 times of deposition steps were repeated to obtain the total thickness of the anode active material layer 22B of 6 μm.

TABLE 4
Anode active material: silicon

| | | | | | | Storage |
|---|---|---|---|---|---|---|
| | | Other nonaqueous | | Elec- | Cycle | reten- |
| | Non- | solvent | | tro- | retention | tion |
| | aqueous | | Content | lyte | ratio | ratio |
| Table 4 | solvent | Type | (wt %) | salt | (%) | (%) |
| Example 4-1 | EC + | (1-4) | 0.01 | LiPF₆ | 44 | 85 |
| Example 4-2 | DEC | | 1 | | 50 | 89 |
| Example 4-3 | | | 2 | | 51 | 90 |
| Example 4-4 | | | 5 | | 50 | 89 |
| Example 4-5 | | | 10 | | 48 | 88 |
| Example 4-6 | | (1-20) | 1 | | 47 | 86 |
| Example 4-7 | | | 2 | | 48 | 87 |
| Example 4-8 | | | 5 | | 46 | 87 |
| Example 4-9 | EC + | — | — | LiPF₆ | 40 | 83 |
| Example 4-10 | DEC | 13 | 1 | | 36 | 84 |
| Example 4-11 | | 14 | 1 | | 40 | 84 |

In the case where silicon was used as an anode active material, results similar to those in the case of using the carbon material (Table 1) were obtained. That is, in the case where the cyclic polyester was used, the cycle retention ratio and the storage retention ratio were higher than those in the case of not using the cyclic polyester.

### Examples 5-1 to 5-14

Secondary batteries were fabricated by a procedure similar to that of Examples 4-2 and 4-9 except that the composition of the nonaqueous solvent was changed as illustrated in Table 5, and the respective characteristics were examined. In this case, the mixture ratio of EC, DMC and the like was EC:DMC=50:50, EC:EMC=50:50, PC:DEC=50:50, and EC:PC:DEC=10:20:70 at a weight ratio. The content of VC, DFDMC, FEC, and DFEC was 5 wt %, and the content of PRS, SBAH, and SPAH was 1 wt %.

TABLE 5
Anode active material: silicon

| | | | Other nonaqueous | | | | |
|---|---|---|---|---|---|---|---|
| | | | solvent | | | Cycle retention | Storage |
| | | | | Content | | ratio | retention ratio |
| Table 5 | Nonaqueous solvent | | Type | (wt %) | Electrolyte salt | (%) | (%) |
| Example 5-1 | EC + DMC | | (1-4) | 1 | LiPF₆ | 50 | 88 |
| Example 5-2 | EC + EMC | | | | | 50 | 88 |
| Example 5-3 | PC + DEC | | | | | 48 | 91 |
| Example 5-4 | EC + PC + DEC | | | | | 48 | 90 |
| Example 5-5 | EC + DEC | VC | | | | 72 | 92 |
| Example 5-6 | | DFDMC | | | | 82 | 90 |
| Example 5-7 | | FEC | | | | 82 | 90 |
| Example 5-8 | | DFEC | | | | 88 | 90 |
| Example 5-9 | | PRS | | | | 50 | 95 |
| Example 5-10 | | SBAH | | | | 51 | 95 |
| Example 5-11 | | SPAH | | | | 52 | 96 |
| Example 5-12 | EC + DEC | VC | — | — | LiPF₆ | 70 | 88 |
| Example 5-13 | | FEC | | | | 66 | 90 |
| Example 5-14 | | DFEC | | | | 80 | 90 |

In the case where silicon was used as an anode active material, high cycle retention ratio and high storage retention ratio were obtained as in the case of using the carbon material (Table 2) even if the composition of the nonaqueous solvent was changed.

### Examples 6-1 to 6-4

Secondary batteries were fabricated by a procedure similar to that of Example 4-2 except that the composition of the electrolyte salt was changed as in Examples 3-1 to 3-4 as illustrated in Table 6, and the respective characteristics were examined.

TABLE 6
Anode active material: silicon

| | | Other nonaqueous | | | | | |
|---|---|---|---|---|---|---|---|
| | | solvent | | | | Cycle retention | Storage |
| | Nonaqueous | | Content | | | ratio | retention ratio |
| Table 6 | solvent | Type | (wt %) | Electrolyte salt | | (%) | (%) |
| Example 6-1 | EC + DEC | (1-4) | 1 | LiPF₆ | LiBF₄ | 50 | 91 |
| Example 6-2 | | | | | LiPF₂O₂ | 48 | 90 |
| Example 6-3 | | | | | LiTFOB | 50 | 93 |
| Example 6-4 | | | | | LiTFSI | 50 | 92 |

In the case where silicon was used as an anode active material, high cycle retention ratio and high storage retention ratio were obtained as in the case of using the carbon material (Table 3) even if the composition of the electrolyte salt was changed.

### Examples 7-1 to 7-4

Secondary batteries were fabricated by a procedure similar to that of Examples 1-3 and 1-11 to 1-13 except that the SnCoC-containing material was used as an anode active material as illustrated in Table 7, and the respective characteristics were examined.

In forming the anode 22, first, cobalt powder and tin powder were alloyed to obtain cobalt tin alloy powder. After that, the resultant was added with carbon powder and dry-mixed. Subsequently, 10 g of the foregoing mixture and about 400 g of a corundum being 9 mm in diameter were set in a reaction container of a planetary ball mill (manufactured by Ito Seisakusho Co.). Subsequently, inside of the reaction container was substituted with argon atmosphere. After that, 10 minute operation at 250 rpm and 10 minute break were repeated until the total operation time reached 20 hours. Subsequently, the reaction container was cooled down to room temperature and the SnCoC-containing material was taken out. After that, the resultant was screened through a 280 mesh sieve to remove coarse grain.

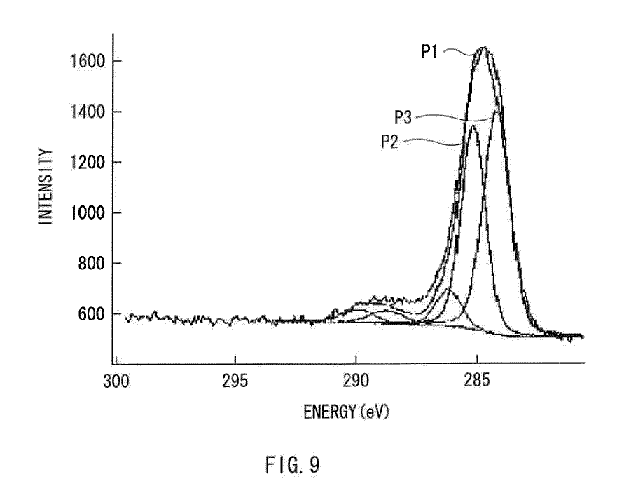

The composition of the obtained SnCoC-containing material was analyzed. The tin content was 49.5 mass %, the cobalt content was 29.7 mass %, the carbon content was 19.8 mass %, and the ratio of tin and cobalt (Co/(Sn+Co)) was 37.5 mass %. At this time, the tin content and the cobalt content were measured by Inductively Coupled Plasma (ICP) emission analysis, and the carbon content was measured by carbon sulfur analysis equipment. Further, the SnCoC-containing material was analyzed by X-ray diffraction method. A diffraction peak having 1 deg or more half-width in the range of 2θ=20 to 50 deg was observed. Further, when the SnCoC-containing material was analyzed by XPS, as illustrated in FIG. 9, peak P1 was obtained. When the peak P1 was analyzed, peak P2 of the surface contamination carbon and peak P3 of C1s in the SnCoC-containing material existing on the lower energy side (region lower than 284.5 eV) were obtained. From the result, it was confirmed that carbon in the SnCoC-containing material was bonded to other element.

After the SnCoC-containing material was obtained, 80 parts by mass of the SnCoC-containing material as an anode active material, 8 parts by mass of polyvinylidene fluoride as an anode binder, 11 parts by mass of graphite as an anode electrical conductor, and 1 part by mass of acetylene black were mixed to obtain an anode mixture. Subsequently, the anode mixture was dispersed in N-methyl-2-pyrrolidone to obtain paste anode mixture slurry. Finally, both faces of the anode current collector 22A were uniformly coated with the anode mixture slurry by using a coating device and the resultant was dried to form the anode active material layer 22B. After that, the coating was compression-molded by using a rolling press machine.

TABLE 7
Anode active material: SnCoC-containing material

| | | Other | | | Cycle | |
|---|---|---|---|---|---|---|
| | | nonaqueous | | | re- | Storage |
| | | solvent | | Elec- | tention | retention |
| | Nonaqueous | | Content | trolyte | ratio | ratio |
| Table 7 | solvent | Type | (wt %) | salt | (%) | (%) |
| Example | EC + DMC | (1-4) | 1 | LiPF₆ | 80 | 88 |
| 7-1 | | | | | | |
| Example | EC + DMC | — | — | LiPF₆ | 70 | 76 |
| 7-2 | | | | | | |
| Example | | 13 | 1 | | 66 | 77 |
| 7-3 | | | | | | |
| Example | | 14 | 1 | | 70 | 77 |
| 7-4 | | | | | | |

In the case where the SnCoC-containing material was used as an anode active material, results similar to those in the case of using the carbon material (Table 1) and in the case of using silicon (Table 4) were obtained. That is, in the case where the cyclic polyester was used, the cycle characteristics and the storage retention ratio were higher than in the case of not using the cyclic polyester.

### Examples 8-1 to 8-6

Secondary batteries were fabricated by a procedure similar to that of Examples 4-2 and 4-9 except that both the oxide-containing film and the metal material or one thereof was formed as illustrated in Table 8, and the respective characteristics were examined.

In forming the oxide-containing film, first, a plurality of anode active material particles were formed by a procedure similar to that of Examples 4-1 to 4-11. After that, silicon oxide (SiO₂) was precipitated on the surface of the anode active material particles by using liquid-phase precipitation method. In this case, the anode current collector 22A on which the anode active material particles were formed was dipped in a solution in which boron as an anion capture agent was dissolved in hydrofluosilic acid for three hours, and the silicon oxide was precipitated on the surface of the anode active material particles. After that, the resultant was washed with water and then dried under reduced pressure.

In forming the metal material, with the use of electrolytic plating method, a current was applied while air was supplied to a plating bath to grow a cobalt (Co) plating film in a gap between each anode active material particle. In this case, a cobalt plating solution (manufactured by Japan Pure Chemical Co., Ltd.) was used as a plating solution, the current density was from 2 A/dm² to 5 A/dm² both inclusive, and the plating rate was 10 nm/sec.

TABLE 8
Anode active material: silicon

| | | | Electrolytic solution | | | | | |
|---|---|---|---|---|---|---|---|---|
| | Anode | | | Other nonaqueous | | | Cycle | Storage |
| | Oxide- | | | solvent | | | retention | retention |
| | containing | Metal | Nonaqueous | | Content | Electrolyte | ratio | ratio |
| Table 8 | film | material | solvent | Type | (wt %) | salt | (%) | (%) |
| Example 8-1 | SiO₂ | — | EC + DEC | (1-4) | 1 | LiPF₆ | 75 | 90 |
| Example 8-2 | — | Co | | | | | 72 | 90 |
| Example 8-3 | SiO₂ | Co | | | | | 80 | 90 |
| Example 8-4 | SiO₂ | — | EC + DEC | — | — | LiPF₆ | 70 | 85 |
| Example 8-5 | — | Co | | | | | 65 | 80 |
| Example 8-6 | SiO₂ | Co | | | | | 72 | 84 |

In the case where the oxide-containing film and the metal material were formed, high cycle retention ratio and high storage retention ratio were obtained as the result of Table 4. In particular, in the case where both the oxide-containing film and the metal material were formed, the cycle retention ratio was higher than in a case that only one thereof was formed. Further, in the case where only the oxide-containing film was formed, the cycle retention ratio was higher than in a case that only the metal material was formed.

From the foregoing results of Table 1 to Table 8, the following was confirmed. That is, in the secondary battery of the application, the nonaqueous solvent of the electrolytic solution contains the cyclic polyester. Thus, the cycle characteristics and the storage characteristics are improved without depending on the type of the anode active material, the composition of the nonaqueous solvent, the type of the electrolyte salt, presence of the oxide-containing film, presence of the metal material and the like.

In this case, the increase ratios of the cycle retention ratio and the storage retention ratio in the case that the metal material (silicon or the SnCoC-containing material) was used as an anode active material were larger than those in the case that the carbon material (artificial graphite) was used as an anode active material. Accordingly, higher effect is able to be obtained in the case that the metal material (silicon or the SnCoC-containing material) was used as an anode active material than in the case that the carbon material (artificial graphite) was used as an anode active material. The result may be obtained for the following reason. That is, in the case where the metal material advantageous to realizing a high capacity was used as an anode active material, the electrolytic solution was more easily decomposed than in a case that the carbon material was used. Accordingly, decomposition inhibition effect of the electrolytic solution was significantly demonstrated.

The application has been described with reference to the embodiment and the examples. However, the application is not limited to the aspects described in the embodiment and the examples, and various modifications may be made. For example, use application of the cyclic polyester of the application is not necessarily limited to the secondary battery, but may be other electrochemical device. Examples of other use applications include a capacitor.

Further, in the foregoing embodiment and the foregoing examples, the description has been given of the lithium ion secondary battery or the lithium metal secondary battery as a secondary battery type. However, the secondary battery of the application is not limited thereto. The application is similarly applicable to a secondary battery in which the anode capacity includes the capacity by inserting and extracting lithium ions and the capacity associated with precipitation and dissolution of lithium metal, and the anode capacity is expressed by the sum of these capacities. In this case, an anode material capable of inserting and extracting lithium ions is used as an anode active material, and the chargeable capacity of the anode material is set to a smaller value than the discharge capacity of the cathode.

Further, in the foregoing embodiment and the foregoing examples, the description has been given with the specific examples of the case in which the battery structure is the cylindrical type or the laminated film type, and with the specific example in which the battery element has the spirally wound structure. However, applicable structures are not limited thereto. The secondary battery of the application is able to be similarly applied to a battery having other battery structure such as a square type battery, a coin type battery, and a button type battery or a battery in which the battery element has other structure such as a laminated structure.

Further, in the foregoing embodiment and the foregoing examples, the description has been given of the case using lithium as an element of a substance (carrier) inserting in or extracting from the cathode and the anode. However, the carrier is not necessarily limited thereto. As a carrier, for example, other Group 1 element such as sodium (Na) and potassium (K), a Group 2 element such as magnesium and calcium, or other light metal such as aluminum may be used. The effect of the application is able to be obtained without depending on the carrier type, and thus even if the carrier type is changed, similar effect is able to be obtained.

Further, in the foregoing embodiment and the foregoing examples, for the content of the cyclic polyester, the description has been given of the appropriate range derived from the results of the examples. However, the description does not totally deny a possibility that the content is out of the foregoing range. That is, the foregoing appropriate range is the range particularly preferable for obtaining the effects of the application. Therefore, as long as effect of the application is obtained, the content may be out of the foregoing range in some degrees.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

1. A secondary battery comprising:
a cathode;
an anode; and
an electrolytic solution containing a nonaqueous solvent and an electrolyte salt,
wherein the nonaqueous solvent contains cyclic polyester obtained by dehydrating and condensing two or more divalent carboxylic acid and one or more divalent alcohol.

2. The secondary battery according to claim 1, wherein the cyclic polyester is a cyclic compound expressed by Formula 1: 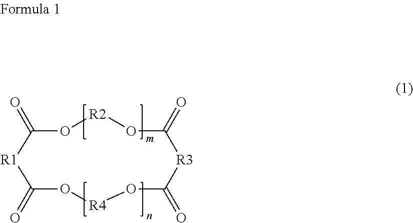
where R1 to R4 are a divalent organic group, m and n are one of integer numbers 0 to 3, and m and n satisfy m+n≧1.

3. The secondary battery according to claim 2, wherein the R1 to the R4 are a carbon hydride group or a halogenated carbon hydride group.

4. The secondary battery according to claim 2, wherein the R1 to the R4 are an alkylene group having carbon number from 1 to 20 both inclusive or a halogenated alkylene group having carbon number from 1 to 20 both inclusive, and
the m and the n are respectively a number equal to or greater than 1.

5. The secondary battery according to claim 2, wherein the cyclic compound is a compound expressed by Formula (1-1) to Formula (1-24).

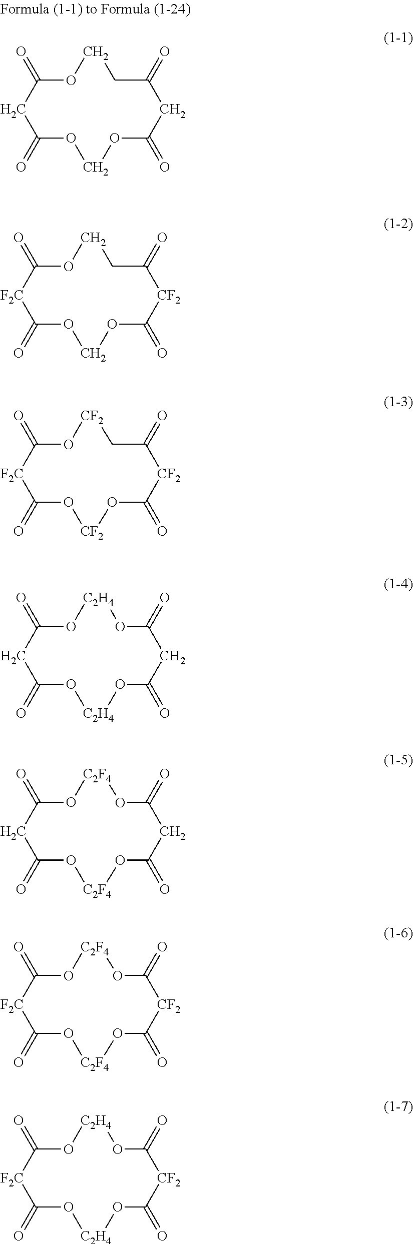

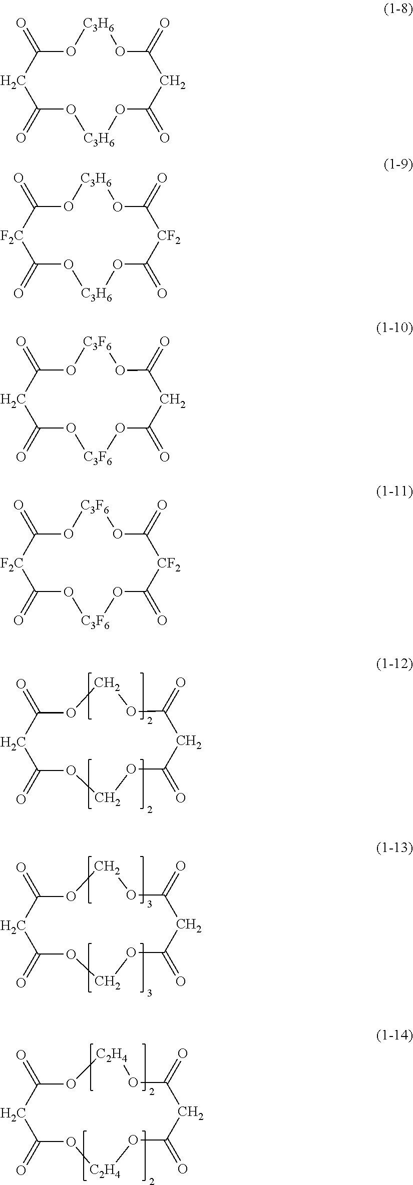

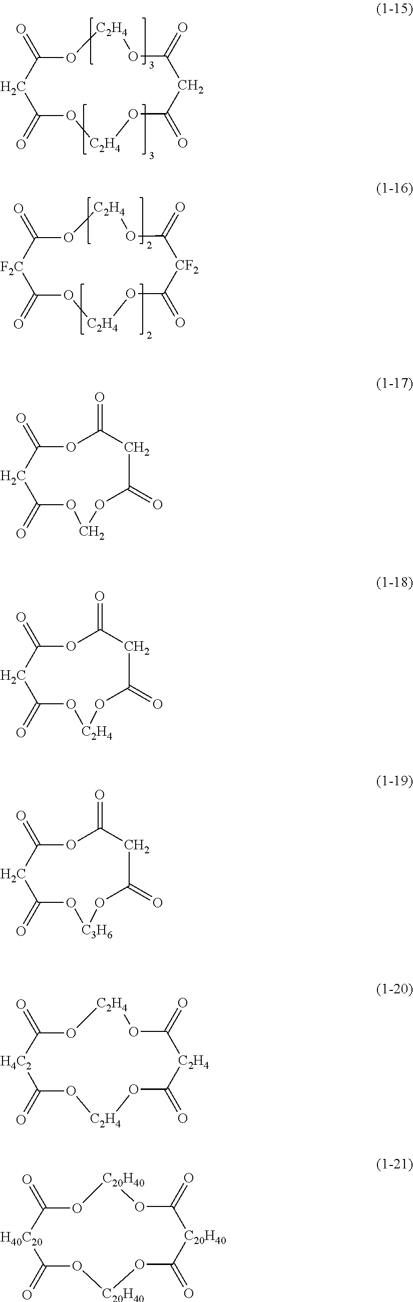

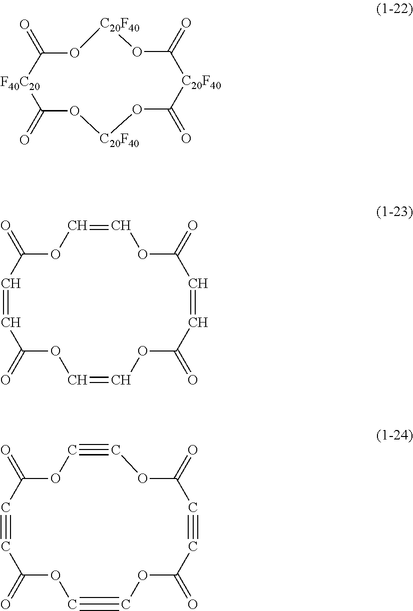

6. The secondary battery according to claim 1, wherein content of the cyclic polyester in the nonaqueous solvent is from 0.01 wt % to 10 wt % both inclusive.

7. The secondary battery according to claim 1, wherein the anode contains, as an anode active material, a carbon material, lithium metal (Li), or a material that is able to insert and extract lithium ions and contains at least one of metal elements and metalloid elements as an element.

8. The secondary battery according to claim 1, wherein the anode contains, as an anode active material, a material containing at least one of silicon (Si) and tin (Sn) as an element.

9. The secondary battery according to claim 8, wherein the material containing at least one of the silicon and the tin as an element is silicon simple substance or SnCoC-containing material containing tin, cobalt (Co), and carbon (C) as an element,
wherein in the SnCoC-containing material, carbon content is from 9.9 mass % to 29.7 mass % both inclusive, and ratio of tin and cobalt (Co/(Sn+Co)) is from 20 mass % to 70 mass % both inclusive, and half-width of diffraction peak obtained by X-ray diffraction is 1.0 deg or more.

10. The secondary battery according to claim 1, wherein the secondary battery is a lithium secondary battery.

11. An electrolytic solution for a secondary battery containing a nonaqueous solvent and an electrolyte salt,
wherein the nonaqueous solvent contains cyclic polyester obtained by dehydrating and condensing two or more divalent carboxylic acid and one or more divalent alcohol.

12. A cyclic polyester expressed by Formula 1: 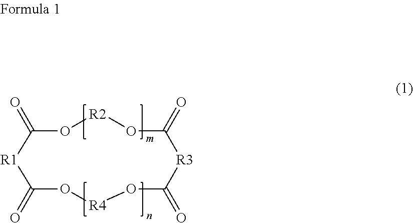
where R1 to R4 are a divalent organic group, m and n are one of integer numbers 0 to 3, and m and n satisfy m+n≧1.

13. An electric power tool mounting a secondary battery including a cathode, an anode, and an electrolytic solution and moving with the use of the secondary battery as a power source,
wherein the electrolytic solution contains a nonaqueous solvent and an electrolyte salt, and
the nonaqueous solvent contains cyclic polyester obtained by dehydrating and condensing two or more divalent carboxylic acid and one or more divalent alcohol.

14. An electrical vehicle mounting a secondary battery including a cathode, an anode, and an electrolytic solution and working with the use of the secondary battery as a power source,
wherein the electrolytic solution contains a nonaqueous solvent and an electrolyte salt, and
the nonaqueous solvent contains cyclic polyester obtained by dehydrating and condensing two or more divalent carboxylic acid and one or more divalent alcohol.

15. An electric power storage system mounting a secondary battery including a cathode, an anode, and an electrolytic solution and using the secondary battery as an electric power storage source,
wherein the electrolytic solution contains a nonaqueous solvent and an electrolyte salt, and
the nonaqueous solvent contains cyclic polyester obtained by dehydrating and condensing two or more divalent carboxylic acid and one or more divalent alcohol.
